(19) United States
(12) Patent Application Publication
(10) Pub. No.: US 2025/0119224 A1
(43) Pub. Date: Apr. 10, 2025

(54) TWO-STAGE FREQUENCY DOMAIN MACHINE LEARNING-BASED CHANNEL STATE FEEDBACK

(71) Applicant: QUALCOMM Incorporated, San Diego, CA (US)

(72) Inventors: Pavan Kumar VITTHALADEVUNI, San Diego, CA (US); Jay Kumar SUNDARARAJAN, San Diego, CA (US); Taesang YOO, San Diego, CA (US); Naga BHUSHAN, San Diego, CA (US); Krishna Kiran MUKKAVILLI, San Diego, CA (US)

(21) Appl. No.: 18/484,269

(22) Filed: Oct. 10, 2023

(51) Int. Cl. H04B 17/391; H04B 7/06

(52) U.S. Cl. CPC H04B 17/3913; H04B 7/0626

(57) ABSTRACT

Methods, systems, and devices for wireless communications are described. A user equipment (UE) may communicate signaling with a network entity, the signaling indicating a first bandwidth size and a second bandwidth size associated with a projection parameter (W1) and a compression parameter (W2), respectively. The second bandwidth size may be less than the first bandwidth size. In some cases, the UE may determine W1 and W2 based on a first machine learning (ML) model and a second ML model, respectively. The UE may project a portion of received channel state information (CSI) associated with the first bandwidth size onto a sub-space defined by W1 and may compress a portion of the projection associated with the second bandwidth size based on W2. The UE may transmit channel state feedback including the projection, the compression of the projection, a compression of W1, a compression of W2, or any combination thereof.

### FIELD OF TECHNOLOGY

The following relates to wireless communications, including two-stage frequency domain machine learning (ML)-based channel state feedback.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may transmit channel state feedback to a network entity. In some cases, the UE may transmit the channel state feedback based on receiving signaling from the network entity, and the UE may generate and transmit the channel state feedback based on a first set of vectors (e.g., defining or otherwise within a sub-space), W1, and a second set of right singular vectors, W2. In some examples, transmitting the channel state feedback signaling may involve a relatively significant signaling overhead in the wireless communications system.

### SUMMARY

The described techniques relate to improved methods, systems, devices, and apparatuses that support two-stage frequency domain machine learning (ML)-based channel state feedback. For example, the described techniques may provide for an improved signaling overhead associated with channel state feedback reporting. A user equipment (UE) may communicate signaling with a network entity, where the signaling may indicate a first bandwidth size and a second bandwidth size associated with a first set of vectors (e.g., defining a sub-space, such as using a projection parameter), W1, and a second set of right singular vectors (e.g., a compression parameter), W2, respectively. In some cases, the UE may apply W1 over at least a first frequency range having the first bandwidth size and may apply W2 over at least a second frequency range having the second bandwidth size to perform channel projection and compression, obtaining channel state feedback for the channel. In some cases, the second bandwidth size may be less than (e.g., have a greater granularity than) the first bandwidth size. Additionally, or alternatively, the second frequency range may be a subset of the first frequency range.

In some examples, the UE may receive signaling (e.g., a sounding signal, a reference signal) from the network entity and may determine channel state information (CSI) based on the signaling. In some examples, the UE may receive the signaling via at least part of the first frequency range. The UE may measure the channel (e.g., the radio channel) based on the signaling and may perform a projection procedure on at least a portion of the channel based on W1 applied over at least the first frequency range. The UE may additionally perform a compression procedure on at least a portion of the channel based on W2 applied over at least the second frequency range. The UE may transmit channel state feedback based on the projection procedure, the compression procedure, or both. For example, the UE may project a portion of the received channel (e.g., CSI for the channel) onto a sub-space using W1 and may compress the projected portion of the channel based on W2. In some cases, the UE may perform the projection and compression based on a first ML model (e.g., a first neural network or other ML model) and a second ML model (e.g., a second neural network or other ML model), respectively. In some cases, the UE may transmit, to the network entity, the channel state feedback including the projection of the portion of the channel based on W1 (e.g., a sub-space identification), the compression of the projection of the portion of the channel based on W2 (e.g., the compressed channel or components in the sub-space), a compression of W1, a compression of W2, or any combination thereof.

A method by a UE is described. The method may include communicating first signaling indicating a first bandwidth size and a second bandwidth size that is less than the first bandwidth size, the first bandwidth size corresponding to a first ML model for channel projection and the second bandwidth size corresponding to a second ML model for vector compression, receiving second signaling indicating CSI, and transmitting a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both.

A UE is described. The UE may include one or more memories and one or more processors coupled with the one or more memories and individually or collectively configured to communicate first signaling indicating a first bandwidth size and a second bandwidth size that is less than the first bandwidth size, the first bandwidth size corresponding to a first ML model for channel projection and the second bandwidth size corresponding to a second ML model for vector compression, receive second signaling indicating CSI, and transmit a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both.

Another UE is described. The UE may include means for communicating first signaling indicating a first bandwidth size and a second bandwidth size that is less than the first bandwidth size, the first bandwidth size corresponding to a first ML model for channel projection and the second bandwidth size corresponding to a second ML model for vector compression, means for receiving second signaling indicating CSI, and means for transmitting a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both.

A non-transitory computer-readable medium storing code is described. The code may include instructions executable by a processor to communicate first signaling indicating a first bandwidth size and a second bandwidth size that is less than the first bandwidth size, the first bandwidth size corresponding to a first ML model for channel projection and the second bandwidth size corresponding to a second ML model for vector compression, receive second signaling indicating CSI, and transmit a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both.

In some examples of the method, UEs, and non-transitory computer-readable medium described herein, communicating the first signaling may include operations, features, means, or instructions for receiving configuration signaling indicating the first bandwidth size, the second bandwidth size, or both for the channel state feedback message.

In some examples of the method, UEs, and non-transitory computer-readable medium described herein, communicating the first signaling may include operations, features, means, or instructions for transmitting a request for the first bandwidth size, the second bandwidth size, or both and receiving, in response to the request, configuration signaling indicating the first bandwidth size, the second bandwidth size, or both for the channel state feedback message.

In some examples of the method, UEs, and non-transitory computer-readable medium described herein, communicating the first signaling may include operations, features, means, or instructions for selecting the first bandwidth size, the second bandwidth size, or both for the channel state feedback message and transmitting an indication of the first bandwidth size, the second bandwidth size, or both based on the selecting.

Some examples of the method, UEs, and non-transitory computer-readable medium described herein may further include operations, features, means, or instructions for communicating the first signaling may be based on a change in one or more channel metrics.

Some examples of the method, UEs, and non-transitory computer-readable medium described herein may further include operations, features, means, or instructions for transmitting third signaling requesting an update to a resource allocation for the channel state feedback message based on the change in the one or more channel metrics.

Some examples of the method, UEs, and non-transitory computer-readable medium described herein may further include operations, features, means, or instructions for receiving third signaling indicating a configuration for transmitting the channel state feedback message, where transmitting the channel state feedback message may be based on the configuration.

In some examples of the method, UEs, and non-transitory computer-readable medium described herein, transmitting the channel state feedback message may include operations, features, means, or instructions for transmitting, based on the configuration, an aperiodic channel state feedback message including a first compression of a first parameter indicating the sub-space of the codebook for the projection, a second compression of a second parameter indicating the compression of the subset of the projection, or both.

In some examples of the method, UEs, and non-transitory computer-readable medium described herein, transmitting the channel state feedback message may include operations, features, means, or instructions for transmitting, according to the first periodicity, a first channel state feedback message including a first compression of a first parameter indicating the sub-space of the codebook for the projection and transmitting, according to the second periodicity, a second channel state feedback message including a second compression of a second parameter indicating the compression of the subset of the projection.

In some examples of the method, UEs, and non-transitory computer-readable medium described herein, the third signaling includes a radio resource control (RRC) message, a medium access control (MAC) control message, or a downlink control information (DCI) message.

Some examples of the method, UEs, and non-transitory computer-readable medium described herein may further include operations, features, means, or instructions for transmitting capability information for the UE indicating that the UE supports the first ML model for the channel projection and the second ML model for the vector compression, where communicating the first signaling may be based on the capability information for the UE.

In some examples of the method, UEs, and non-transitory computer-readable medium described herein, the channel state feedback message includes a first set of bits indicating a first compression of a first parameter indicating the sub-space of the codebook for the projection, a second set of bits indicating a second compression of a second parameter indicating the compression of the subset of the projection, or both and a first quantity of the first set of bits may be larger than a second quantity of the second set of bits.

In some examples of the method, UEs, and non-transitory computer-readable medium described herein, the codebook includes a non-discrete Fourier transform (DFT) codebook of a set of non-DFT codebooks.

A method by a network entity is described. The method may include communicating first signaling indicating a first bandwidth size and a second bandwidth size that is less than the first bandwidth size, the first bandwidth size corresponding to a first ML model for channel projection and the second bandwidth size corresponding to a second ML model for vector compression, transmitting, for a UE, second signaling indicating CSI, and receiving a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both.

A network entity is described. The network entity may include one or more memories and one or more processors coupled with the one or more memories and individually or collectively configured to communicate first signaling indicating a first bandwidth size and a second bandwidth size that is less than the first bandwidth size, the first bandwidth size corresponding to a first ML model for channel projection and the second bandwidth size corresponding to a second ML model for vector compression, transmit, for a UE, second signaling indicating CSI, and receive a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both.

Another network entity is described. The network entity may include means for communicating first signaling indicating a first bandwidth size and a second bandwidth size that is less than the first bandwidth size, the first bandwidth size corresponding to a first ML model for channel projection and the second bandwidth size corresponding to a second ML model for vector compression, means for transmitting, for a UE, second signaling indicating CSI, and means for receiving a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both.

A non-transitory computer-readable medium storing code is described. The code may include instructions executable by a processor to communicate first signaling indicating a first bandwidth size and a second bandwidth size that is less than the first bandwidth size, the first bandwidth size corresponding to a first ML model for channel projection and the second bandwidth size corresponding to a second ML model for vector compression, transmit, for a UE, second signaling indicating CSI, and receive a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both.

In some examples of the method, network entities, and non-transitory computer-readable medium described herein, communicating the first signaling may include operations, features, means, or instructions for transmitting configuration signaling indicating the first bandwidth size, the second bandwidth size, or both for the channel state feedback message.

In some examples of the method, network entities, and non-transitory computer-readable medium described herein, communicating the first signaling may include operations, features, means, or instructions for receiving a request for the first bandwidth size, the second bandwidth size, or both and transmitting, in response to the request, configuration signaling indicating the first bandwidth size, the second bandwidth size, or both for the channel state feedback message.

In some examples of the method, network entities, and non-transitory computer-readable medium described herein, communicating the first signaling may include operations, features, means, or instructions for receiving an indication of the first bandwidth size, the second bandwidth size, or both used for the channel state feedback message.

In some examples of the method, network entities, and non-transitory computer-readable medium described herein, communicating the first signaling may be based on a change in one or more channel metrics for the UE.

Some examples of the method, network entities, and non-transitory computer-readable medium described herein may further include operations, features, means, or instructions for transmitting third signaling updating a resource allocation for the channel state feedback message based on the change in the one or more channel metrics.

Some examples of the method, network entities, and non-transitory computer-readable medium described herein may further include operations, features, means, or instructions for receiving fourth signaling requesting an update to the resource allocation for the channel state feedback message, where transmitting the third signaling updating the resource allocation may be further based on the fourth signaling.

Some examples of the method, network entities, and non-transitory computer-readable medium described herein may further include operations, features, means, or instructions for transmitting third signaling indicating a configuration for transmitting the channel state feedback message, where receiving the channel state feedback message may be based on the configuration.

In some examples of the method, network entities, and non-transitory computer-readable medium described herein, receiving the channel state feedback message may include operations, features, means, or instructions for receiving, based on the configuration, an aperiodic channel state feedback message including a first compression of a first parameter indicating the sub-space of the codebook for the projection, a second compression of a second parameter indicating the compression of the subset of the projection, or both.

In some examples of the method, network entities, and non-transitory computer-readable medium described herein, receiving the channel state feedback message may include operations, features, means, or instructions for receiving, according to the first periodicity, a first channel state feedback message including a first parameter indicating the sub-space of the codebook for the projection and receiving, according to the second periodicity, a second channel state feedback message including a second compression of a second parameter indicating the compression of the subset of the projection.

In some examples of the method, network entities, and non-transitory computer-readable medium described herein, the third signaling includes an RRC message, a MAC control message, or a DCI message.

Some examples of the method, network entities, and non-transitory computer-readable medium described herein may further include operations, features, means, or instructions for receiving capability information for the UE indicating that the UE supports the first ML model for the channel projection and the second ML model for the vector compression, where communicating the first signaling may be based on the capability information for the UE.

In some examples of the method, network entities, and non-transitory computer-readable medium described herein, the channel state feedback message includes a first set of bits indicating a first compression of a first parameter indicating the sub-space of the codebook for the projection, a second set of bits indicating a second compression of a second parameter indicating the compression of the subset of the projection, or both and a first quantity of the first set of bits may be larger than a second quantity of the second set of bits.

In some examples of the method, network entities, and non-transitory computer-readable medium described herein, the codebook includes a non-DFT codebook of a set of non-DFT codebooks.

### BRIEF DESCRIPTION OF THE DRAWINGS

FIG. 1 shows an example of a wireless communications system that supports two-stage frequency domain machine learning (ML)-based channel state feedback in accordance with one or more aspects of the present disclosure.

FIG. 2 shows an example of a network architecture that supports two-stage frequency domain ML-based channel state feedback in accordance with one or more aspects of the present disclosure.

FIG. 3 shows an example of a wireless communications system that supports two-stage frequency domain ML-based channel state feedback in accordance with one or more aspects of the present disclosure.

FIG. 4A shows an example of a resource diagram that supports two-stage frequency domain ML-based channel state feedback in accordance with one or more aspects of the present disclosure.

FIG. 4B shows an example of a flow diagram that supports two-stage frequency domain ML-based channel state feedback in accordance with one or more aspects of the present disclosure.

FIG. 5 shows an example of a process flow that supports two-stage frequency domain ML-based channel state feedback in accordance with one or more aspects of the present disclosure.

FIGS. 6 and 7 show block diagrams of devices that support two-stage frequency domain ML-based channel state feedback in accordance with one or more aspects of the present disclosure.

FIG. 8 shows a block diagram of a communications manager that supports two-stage frequency domain ML-based channel state feedback in accordance with one or more aspects of the present disclosure.

FIG. 9 shows a diagram of a system including a device that supports two-stage frequency domain ML-based channel state feedback in accordance with one or more aspects of the present disclosure.

FIGS. 10 and 11 show block diagrams of devices that support two-stage frequency domain ML-based channel state feedback in accordance with one or more aspects of the present disclosure.

FIG. 12 shows a block diagram of a communications manager that supports two-stage frequency domain ML-based channel state feedback in accordance with one or more aspects of the present disclosure.

FIG. 13 shows a diagram of a system including a device that supports two-stage frequency domain ML-based channel state feedback in accordance with one or more aspects of the present disclosure.

FIGS. 14 through 19 show flowcharts illustrating methods that support two-stage frequency domain ML-based channel state feedback in accordance with one or more aspects of the present disclosure.

### DETAILED DESCRIPTION

In some wireless communications systems, user equipments (UEs) may transmit (e.g., report) channel state feedback to a network entity based on receiving signaling (e.g., a reference signal, a synchronization signal, a sounding signal) over a channel. In some cases, the channel state feedback may be based on the UE performing a compression procedure on channel state information (CSI) determined from the signaling. For example, the compression procedure may include the UE projecting at least a portion of the CSI (e.g., a measurement of the channel) onto a sub-space defined by a set of vectors W1, and the UE performing a singular value decomposition (SVD) on the projected portion of the CSI to obtain one or more right singular vectors W2. The UE may transmit information associated with W1, W2, or both to the network entity. In some cases, the UE may determine W1, W2, or both. Improved techniques for determining and reporting W1, W2, or both may reduce channel state feedback overhead, improve channel state feedback accuracy, or both.

According to techniques described herein, a UE may communicate signaling with a network entity, where the signaling may indicate a first bandwidth size associated with a first set of vectors (e.g., a projection parameter for a sub-space), W1, and a second, different bandwidth size associated with a second set of vectors (e.g., a compression parameter), W2. In some cases, the UE may apply W1 over at least a first frequency range having the first bandwidth size and may apply W2 over at least a second frequency range having the second bandwidth size. In some cases, the second bandwidth size may be less than (e.g., have a greater granularity than) the first bandwidth size. Additionally, or alternatively, the second frequency range may be a subset of the first frequency range.

In some examples, the UE may receive signaling (e.g., a reference signal, a synchronization signal, a sounding signal) from the network entity and may determine CSI for a channel based on the signaling. In some examples, the UE may receive the signaling via at least part of the first frequency range. The UE may perform a compression procedure on at least a portion of the CSI based on W1 and W2 applied over at least the first frequency range and at least the second frequency range, respectively. The UE may transmit channel state feedback based on the compression procedure. For example, the UE may project a portion of the channel (e.g., indicating CSI) onto a sub-space (e.g., using W1) and may compress the projected portion of the channel based on W2. In some cases, the UE may determine W1 and W2 based on a first ML model and a second ML model, respectively. In some cases, the UE may transmit the channel state feedback including the projection of the portion of the CSI based on W1, the compression of the projection of the portion of the CSI based on W2, a compression of W1, a compression of W2, or any combination thereof.

Aspects of the disclosure are initially described in the context of wireless communications systems. Aspects of the disclosure are also described in the context of resource diagrams, flow diagrams, and process flows. Aspects of the disclosure are further illustrated by and described with reference to apparatus diagrams, system diagrams, and flowcharts that relate to two-stage frequency domain ML-based channel state feedback.

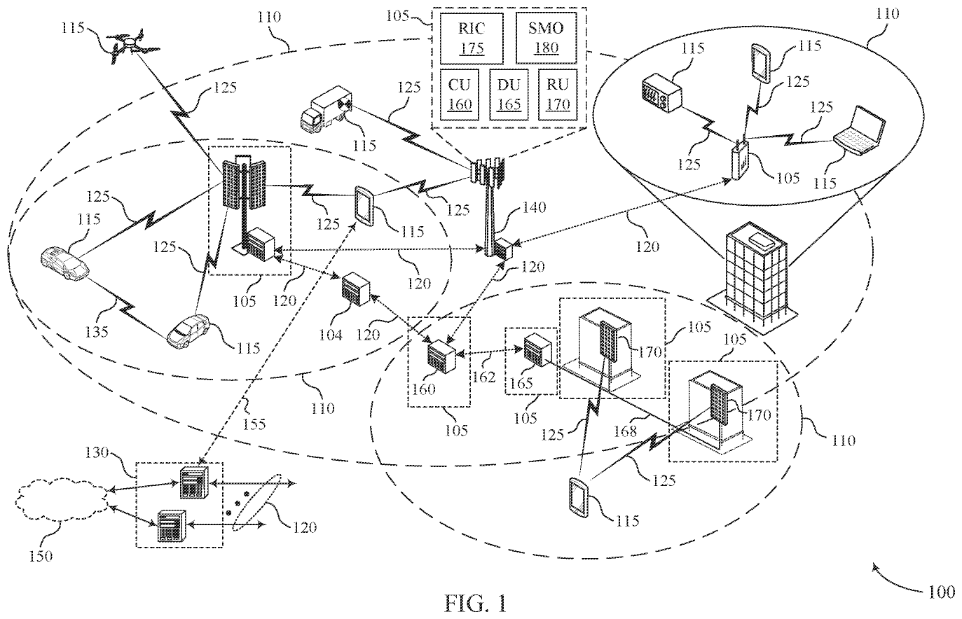

FIG. 1 shows an example of a wireless communications system 100 that supports two-stage frequency domain ML-based channel state feedback in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120), IAB nodes 104 may include an IAB mobile termination (LAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support two-stage frequency domain ML-based channel state feedback as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UB 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

According to techniques described herein, a UE 115 may communicate signaling with a network entity 105, where the signaling may indicate a first bandwidth size associated with channel projection (e.g., associated with a first ML model, a first projection parameter W1) and a second bandwidth size associated with vector compression (e.g., associated with a second ML model, a second compression parameter W2). In some cases, the UE 115 may apply W1 over at least a first frequency range having the first bandwidth size and may apply W2 over at least a second frequency range having the second bandwidth size. In some cases, the second bandwidth size may be less than (e.g., have a greater granularity than) the first bandwidth size. Additionally, or alternatively, the second frequency range may be a subset of the first frequency range.

In some examples, the UE 115 may receive signaling (e.g., a reference signal, a synchronization signal, a sounding signal) from the network entity 105 that indicates CSI. In some examples, the UE 115 may receive the signaling via at least part of the first frequency range. The UE 115 may perform a two-stage CSI computation procedure on the received signaling to determine CSI for channel state feedback. The UE 115 may project at least a portion of the channel (e.g., one or more measurements of the channel, which may be referred to as the channel or Hᵢₙ) onto a sub-space using W1 over at least the first frequency range and may compress at least a portion of the projection of the channel based on W2 over at least the second frequency range. The UE 115 may transmit channel state feedback including CSI based on the two-stage CSI computation procedure. In some cases, the UE 115 may determine the channel projection (e.g., determine W1) based on a first ML model and may determine the channel or vector compression (e.g., determine W2) based on a second ML model. In some cases, the UE 115 may transmit the channel state feedback including the projection of the portion of the CSI based on W1, the compression of the projection of the portion of the CSI based on W2, a compression of W1, a compression of W2, or any combination thereof to the network entity 105.

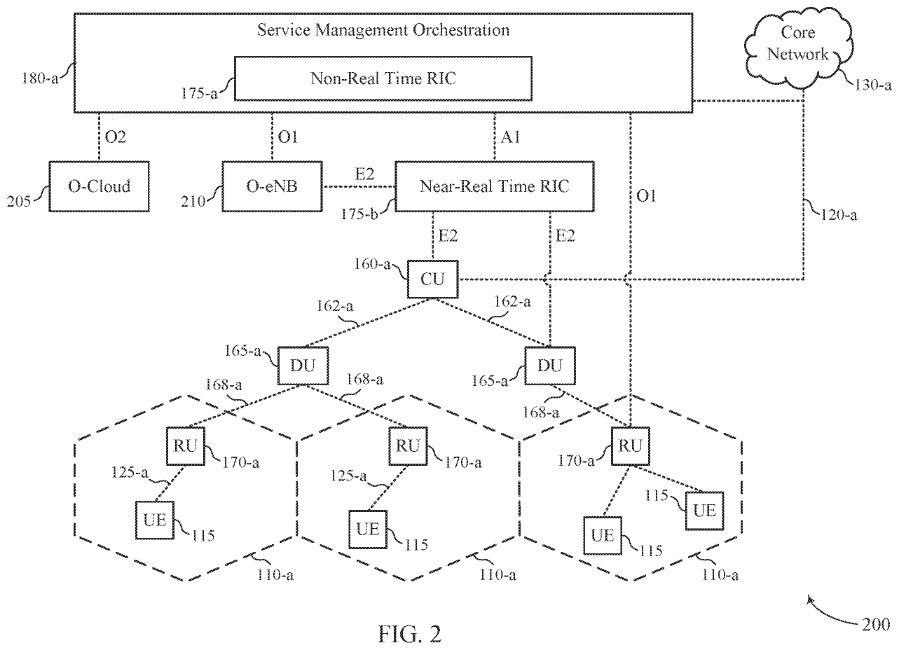

FIG. 2 shows an example of a network architecture 200 that supports two-stage frequency domain ML-based channel state feedback in accordance with one or more aspects of the present disclosure. The network architecture 200 may be an example of a disaggregated base station architecture, a disaggregated RAN architecture, or both. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115 via one or more communication links 125-a. In some implementations, a UE 115 may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (IFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or ML workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

In some cases, a UE 115 may communicate signaling with a network entity 105, where the signaling may indicate a first bandwidth size and a second bandwidth size associated with channel projection and vector compression, respectively. The UE 115 may apply a projection parameter, W1, and a compression parameter, W2, over at least a first frequency range having the first bandwidth size and at least a second frequency range having the second bandwidth size, respectively. Additionally, or alternatively, the UE 115 may receive signaling from the network entity 105, indicating CSI. The UE 115 may perform a multi-stage (e.g., two-stage) CSI computation procedure on at least a portion of the received signaling (e.g., channel measurements) based on W1 and W2 applied over at least the first frequency range and at least the second frequency range, respectively. The UE 115 may transmit channel state feedback indicating the CSI based on the multi-stage CSI computation procedure. One or more network entities 105 may receive and process the channel state feedback. Such network entities 105 may be any combination of an RU 170-a, a DU 165-a, or a CU 160-a.

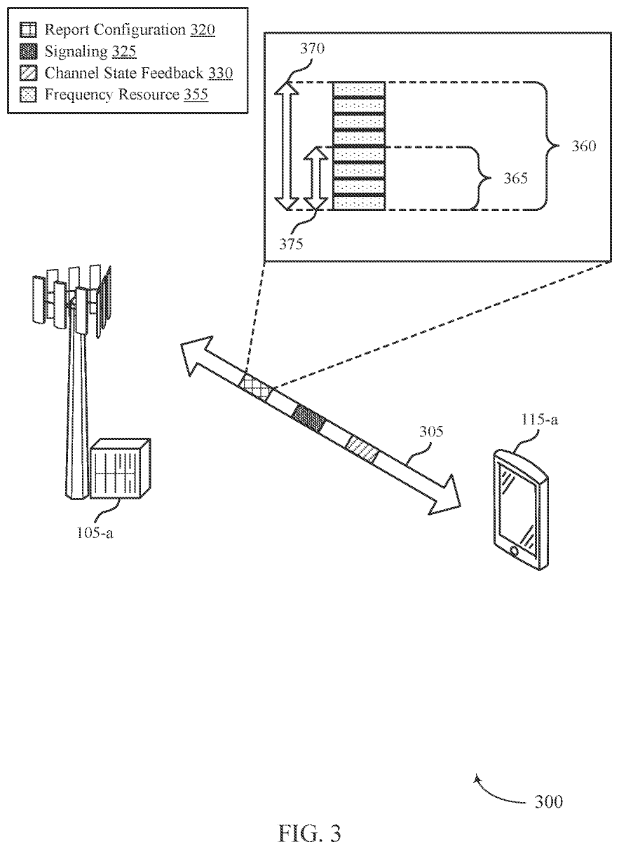

FIG. 3 shows an example of a wireless communications system 300 that supports two-stage frequency domain ML-based channel state feedback in accordance with one or more aspects of the present disclosure. In some cases, aspects of the wireless communications system 300 may implement or be implemented by aspects of a wireless communications system 100 or a network architecture 200 as described herein with reference to FIGS. 1 and 2. For example, the wireless communications system 300 may include a network entity 105-a and a UE 115-a, which may be examples of the network entities 105 and the UEs 115 as described with respect to FIGS. 1 and 2. In some examples, the UB 115-a may transmit channel state feedback 330 to the network entity 105-a based on communicating a report configuration 320 with the network entity 105-a. The report configuration 320 may indicate different frequency granularities for different stages of CSI computation for the channel state feedback 330.

In some cases, the UE 115-a and the network entity 105-a may communicate signaling via a wireless connection 305 which may include multiple channels (e.g., one or more uplink channels, one or more downlink channels, one or more feedback channels). For example, the network entity 105-a may transmit downlink signaling to the UE 115-a via one or more downlink channels of the wireless connection 305. The UE 115-a may transmit uplink signaling to the network entity 105-a via one or more uplink channels of the wireless connection 305. In the wireless communications system 300, the UE 115-a may report channel state feedback 330 to the network entity 105-a via the wireless connection 305.

In some other wireless communications systems, a UE and a network entity may determine CSI using an enhanced CSI procedure (e.g., an eType2 CSI procedure). For example, the UE and the network entity may perform beamformed measurements, in which the network entity may transmit signaling via a channel (e.g., the network entity may sound the channel) using one or more antenna ports, one or more beams, or both. The UE may compress the channel (e.g., using a channel estimation matrix) in a sub-space and may transmit the compressed channel to the network entity.

In some examples, the UE and the network entity of such other wireless communications systems may perform non-beamformed sensing, in which the network entity may transmit signaling via the channel using each antenna port of a set of antenna ports for the network entity. The UE may use an oversampled DFT codebook to determine a set of vectors, W1 (e.g., a sub-space W1 indicated by the vectors), on which to project the channel. In some cases, the UE may use W1 for projection (e.g., wideband projection) of the channel and may perform a singular value decomposition (SVD) on the projected channel to obtain one or more singular right vectors, W2. Additionally, or alternatively, the UE may transmit information associated with W1 and W2 (e.g., a compression of W1 and W2) to the network entity, for example, as part of channel state feedback.

In some cases, for eType2 CSI, the UE may use approximately twelve bits to report W1 (e.g., for wideband compression using a general DFT codebook) and a relatively large quantity of bits to report W2 (e.g., over one hundred bits for rank two communications). The UE may report both W1 and W2 in each channel state feedback message. As such, these other wireless communications systems may experience significant channel overhead associated with channel state feedback, based on the UE reporting more than one hundred bits of information to indicate the W1 and W2 values.

In some other wireless communications systems, a UE and a network entity may implement an ML channel state feedback procedure. In some cases, the ML channel state feedback procedure may include a sub-band level compression of a channel, where the UE may perform the compression without utilizing a W1 projection. In some cases, reporting a W2 value associated with the ML channel state feedback procedure may include relatively fewer bits than reporting a W2 value associated with the enhanced CSI procedure (e.g., reporting the W2 value may still use approximately one hundred bits), and a wireless communications system implementing the MS channel state feedback procedure may experience a similar performance (e.g., latency) as a wireless communications system implementing the enhanced CSI procedure.

In contrast, according to techniques described herein, the UE 115-a may utilize a two-stage frequency domain ML-based channel state feedback procedure to reduce the channel overhead associated with channel state feedback (e.g., significantly reducing the quantity of bits for reporting W2 values). In some examples, the UE 115-a may use a non-DFT-based codebook to determine W1 and project a channel (e.g., a channel estimation matrix) for receiving signaling onto a sub-space (e.g., a smaller sub-space) defined by W1. In some cases, the UB 115-a may project the channel onto the sub-space prior to compressing W1, W2, or both, in some examples, for inclusion in the channel state feedback 330. In some cases, the non-DFT-based codebook may not be known to the network entity 105-a, and the UE 115-a may leam (e.g., determine via an ML procedure or other training) the non-DFT-based codebook and transmit an indication of the non-DFT-based codebook to the network entity 105-a. For example, the UE 115-a may compress the non-DFT-based codebook and transmit the compressed non-DFT-based codebook to the network entity 105-a. In some cases, the UE 115-a may compress the non-DFT-based codebook via an ML-based compression.

In some cases, the UE 115-a may report the W1 and W2 values (e.g., beamforming vectors) according to different time durations associated with signaling communicated between a network entity 105-a and the UE 115-a, where reporting W1 may be associated with a longer time duration than reporting W2. In the wireless communications system 300, the UE 115-a may apply W1 and W2 over bandwidth sizes associated with the signaling 325. For example, the UE 115-a may apply W1 over a frequency range 360 associated with a bandwidth size 370, and the UE 115-a may apply W2 over a frequency range 365 associated with a bandwidth size 375. In some cases, the UB 115-a may receive the signaling 325 via at least the frequency range 360.

In some cases, the bandwidth size 375 may be smaller than (e.g., include fewer frequency resources 355, be more granular, have a greater granularity) the bandwidth size 370. In some examples, the bandwidth size 370 may include 8, 16, or 32 frequency resources 355 (e.g., resource blocks), or the bandwidth size 370 may be a wideband bandwidth size (e.g., span the channel bandwidth). In some such examples, the bandwidth size 375 may include 1, 2, or 4 frequency resources 355. However, the UE 115-a may use any bandwidth sizes for the frequency granularities of performing channel projection and vector compression. Additionally, or alternatively, the frequency range 365 may be a subset (e.g., sub-band) of the frequency range 360.

In accordance with techniques described herein, the UE 115-a and the network entity 105-a may determine CSI based on a two-stage frequency domain ML-based channel state feedback procedure. In some cases, reporting a W1 value associated with the two-stage frequency domain ML-based channel state feedback procedure may include a relatively larger quantity of bits than reporting a W1 value associated with an enhanced CSI procedure. However, reporting a W2 value associated with the two-stage frequency domain ML-based channel state feedback procedure may include a significantly smaller quantity of bits than reporting a W2 value associated with the enhanced CSI procedure. In some cases, the two-stage frequency domain ML-based channel state feedback procedure may be associated with feedback including fewer bits (e.g., total bits, overall bits, bits in some channel state feedback messages) than feedback associated with the ML channel state feedback procedure. For example, a first sum of the quantity of bits for W1 and the quantity of bits for W2 of the two-stage frequency domain ML-based channel state feedback procedure may be less than a second sum of the quantity of bits for W1 and the quantity of bits for W2 of an ML channel state feedback procedure. Accordingly, the UE 115-a may improve the signaling overhead associated with reporting channel state feedback 330.

In some channel realizations, the wireless connection 305 may include a channel for which the channel state feedback 330 frequency granularity may be relatively low (e.g., reporting W2 values at a frequency granularity of 8 or 16 frequency resources 355 or resource blocks). In some such examples, the two-stage frequency domain ML-based channel state feedback procedure may allow for an overhead associated with communicating a W2 value that is relatively smaller than other procedures. Additionally, or alternatively, the W1 value of the two-stage frequency domain ML-based channel state feedback procedure may change relatively more slowly than the W2 values. For example, the W1 value may indicate relatively wideband or large scale parameters. The two-stage frequency domain ML-based channel state feedback procedure may allow for the UE 115-a to indicate the W1 value in the channel state feedback 330 relatively less frequently than other procedures (e.g., once every eight channel state feedback reports, or according to some other periodicity), which may result in relatively lower overhead for channel state feedback 330 communications between the UE 115-a and the network entity 105-a.

In some cases, the W1 and W2 values associated with the two-stage frequency domain ML-based channel state feedback procedure performed by the wireless communications system 300 may be included in a same or different channel state feedback 330 messages. For example, the UE 115-a may indicate the W1 value relatively less frequently in the channel state feedback 330 than the W2 value. In some such examples, the UE 115-a may indicate the W2 value in each instance of channel state feedback 330 (e.g., in response to each CSI-RS instance, each channel state feedback message), and the UE 115-a may not indicate the W1 value in each instance of the channel state feedback 330 (e.g., in one channel state feedback message out of eight channel state feedback messages). In some examples, the UE 115-a may offset reporting different W1 values, W2 values, or both in different channel state feedback 330 messages. For example, the UE 115-a may report a first W1 value in a first channel state feedback 330 message, a set of W2 values in a second channel state feedback 330 message, and a second W1 value (e.g., corresponding to a different sub-band than the first W1 value) in a third channel state feedback 330 message.

In some cases, the UE 115-a may transmit a capability report to the network entity 105-a. For example, the capability report may indicate whether the UE 115-a is capable to perform (e.g., operate in) the enhanced CSI procedure, the ML channel state feedback procedure, the two-stage frequency domain ML-based channel state feedback procedure, or any combination thereof. Additionally, or alternatively, the capability report may indicate frequency granularities supported by the UE 115-a for W1 reporting, W2 reporting, or both.

In some cases, the UE 115-a may communicate a report configuration 320 indicating the first bandwidth size 370, the second bandwidth size 375, or both with the network entity 105-a. In some examples, the network entity 105-a may transmit the report configuration 320 (e.g., in configuration signaling, such as RRC signaling, a MAC control element (CE), downlink control information (DCI) signaling) to the UE 115-a. In some other examples, the UE 115-a may transmit a request to the network entity 105-a for a first (e.g., larger) bandwidth size, a second (e.g., smaller) bandwidth size, or both and may receive the report configuration 320 from the network entity 105-a based on transmitting the request. For example, the network entity 105-a may configure the first bandwidth size 370, the second bandwidth size 375, or both based on the bandwidth sizes requested by the UE 115-a. In some other examples, the UE 115-a may select (e.g., autonomously) the first bandwidth size 370, the second bandwidth size 375, or both and may transmit the report configuration 320 to the network entity 105-a to inform the network of the UE-selected bandwidth size(s). In some cases, communicating the report configuration 320 may be based on a change in one or more channel metrics (e.g., frequency selectivity of a channel associated with the wireless connection 305). For example, the UE 115-a, the network entity 105-a, or both may trigger a change to one or both of the frequency granularities for reporting W1 and W2 based on changing channel conditions.

The UE 115-a may transmit the channel state feedback 330 to the network entity 105-a based on the bandwidth size 370 and the bandwidth size 375. For example, the UB 115-a may transmit the channel state feedback 330 in or as one or more aperiodic channel state feedback messages (e.g., CSI feedback messages). In some cases, the network entity 105-a may configure the UE 115-a (e.g., using the report configuration 320) to transmit information associated with W1, information associated with W2, or both in one or more aperiodic channel state feedback messages. In some cases, the information associated with W1 and the information associated with W2 may be a compression of W1 and a compression of W2, respectively.

In some cases, the channel state feedback 330 may include one or more periodic or semi-persistent CSI messages. For example, the network entity 105-a may configure the UE 115-a to transmit information associated with W1 in a periodic or semi-persistent CSI message associated with a first periodicity. Additionally, or alternatively, the network entity 105-a may configure the UE 115-a to transmit information associated with W2 in a periodic or semi-persistent CSI message associated with a second periodicity. In some cases, the second periodicity may be different than the first periodicity. For example, the second periodicity may be relatively more frequent than the first periodicity, such that the information associated with W1 may be transmitted relatively less often (e.g., to reduce processing overhead at the UE 115-a).

As described herein, the network entity 105-a may configure the UE 115-a via the report configuration 320, via other configuration signaling, or both. For example, the report configuration 320, the other configuration signaling, or both, may include RRC messaging, MAC-CE messaging, DCI messaging, or any combination thereof.

In some cases, a frequency selectivity corresponding to a channel associated with the wireless connection 305 may change. For example (e.g., based on movement of the UE 115-a or other obstacles), the wireless connection 305 may transition for being a line of sight (LoS) wireless connection to being a non-LoS connection, which may alter the channel conditions. The UB 115-a, the network entity 105-a, or both may modify the frequency selectivity corresponding to the channel of the wireless connection 305 based on the altered channel conditions. In some such cases, changing the bandwidth size 370, the bandwidth size 375, or both may improve the accuracy of reporting the channel conditions to the network entity 105-a.

The network entity 105-a, the UE 115-a, or both may detect the change in the frequency selectivity. For example, the UE 115-a may detect the change in the frequency selectivity of the channel and may transmit a request to the network entity 105-a for an indication of one or more bandwidth sizes (e.g., to replace the bandwidth size 370, the bandwidth size 375, or both) based on detecting the change. Additionally, or alternatively, the network entity 105-a may detect the change in the frequency selectivity of the channel and may autonomously transmit an indication of the one or more updated bandwidth sizes based on detecting the change in frequency selectivity. In some examples, the network entity 105-a may transmit the indication of one or more bandwidth sizes via control signaling similar to the report configuration 320.

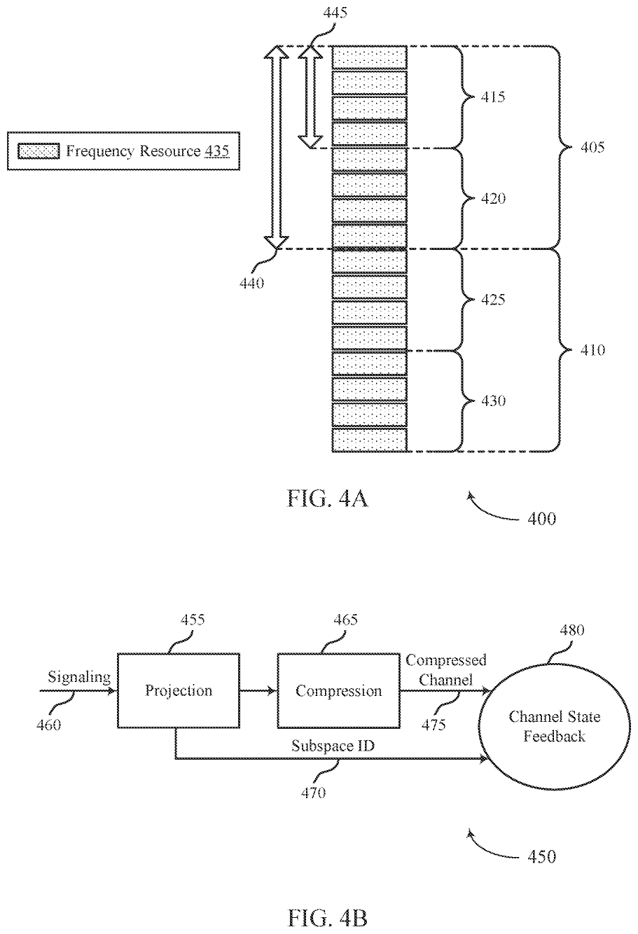

FIG. 4A shows an example of a resource diagram 400 that supports two-stage frequency domain ML-based channel state feedback in accordance with one or more aspects of the present disclosure. In some cases, aspects of the resource diagram 400 may implement or be implemented by aspects of a wireless communications system 100, a network architecture 200, or a wireless communications system 300 as described with reference to FIGS. 1 through 3. For example, the resource diagram 400 may include frequency resources 435, which may be examples of the frequency resources 355 as described with respect to FIG. 3. The resource diagram 400 may also include various frequency ranges, including a frequency range 405 and a frequency range 415, which may be examples of the frequency range 360 and the frequency range 365, respectively, as described herein with reference to FIG. 3. Additionally, the resource diagram 400 may include a bandwidth size 440 and a bandwidth size 445, which may be examples of the bandwidth size 370 and the bandwidth size 375, respectively, as described herein with respect to FIG. 3. In some cases, a UE (e.g., a UE 115) may communicate signaling with a network entity (e.g., a network entity 105) indicating one or more frequency ranges (e.g., including the frequency range 405 and the frequency range 415), and the UE may transmit channel state feedback to the network entity based on the one or more frequency ranges.

As discussed herein, a UE (e.g., a UE 115) may determine a set of vectors (e.g., indicating or mapped to a sub-space), W1, for projecting a channel and one or more right singular vectors, W2, for compressing the projected channel, where the UE 115 may apply W1 to at least a first frequency range (e.g., a channel bandwidth, a sub-band, the frequency range 405, a frequency range 410) associated with the bandwidth size 440 and may apply W2 to at least a second frequency range (e.g., a sub-band, the frequency range 415, a frequency range 420, a frequency range 425, a frequency range 430) associated with a bandwidth size 445. For example, the UB 115 may apply W1 to the channel measurements for one or more of the frequency range 405 and the frequency range 410, which may each include a quantity of frequency resources according to the configured bandwidth size 440 (e.g., 8 resource blocks). Additionally, or alternatively, the UE 115 may apply W2 to the projected channel measurements for one or more of the frequency range 415, the frequency range 420, the frequency range 425, and the frequency range 430, which may each include a quantity of frequency resources according to the bandwidth size 445 (e.g., 4 resource blocks). In some cases, the UE may determine W1 and W2 based on one or more ML models. Additionally, or alternatively, the bandwidth sizes for the frequency ranges for reporting a value (e.g., W1 or W2) may be different (e.g., based on the size of the channel for channel state feedback).

In some cases, the UE 115 may determine W1 based on a DFT-based codebook. In some other cases, the UE 115 may determine W1 based on a non-DFT-based codebook (e.g., the UE 115 may perform more processing than selecting a sub-space from a DFT-based codebook to determine W1). Additionally, or alternatively, the UE 115 may transmit information associated with W1, information associated with W2, or both, to a network entity 105. For example, the UE 115 may transmit a compression of W1, a compression of W2, or both, to the network entity 105. In some cases, the UE 115 may compress W1, W2, or both via one or more ML models (e.g., neural networks). In some cases, the UE 115 may transmit the information associated with W1, the information associated with W2, or both via a CSI feedback message to the network entity 105.

FIG. 4B shows an example of a flow diagram 450 that supports two-stage frequency domain ML-based channel state feedback in accordance with one or more aspects of the present disclosure. In some cases, aspects of the flow diagram 450 may implement or be implemented by aspects of a wireless communications system 100, a network architecture 200, or a wireless communications system 300 as described with reference to FIGS. 1 through 3. For example, the flow diagram 450 may include received signaling 460 (e.g., representing the channel) and channel state feedback 480, which may be examples of signaling 325 and the channel state feedback 330, respectively, communicated between the UE 115-a and the network entity 105-a as described herein with respect to FIG. 3. In some examples, the flow diagram 450 may include actions taken by a UE (e.g., a UE 115) associated with generating (e.g., determining, creating) channel state feedback 480 for inclusion in one or more channel state feedback messages.

For example, a UE 115 may perform a projection 455 of the channel represented by the received signaling 460 (e.g., CSI-RSs, synchronization signal blocks (SSBs), or other signaling). In some examples, the received signaling 460 may indicate CSI for the channel. In some cases, the received signaling 460 may be a reference signal or channel sounding signal, and the received signaling may indicate CSI. In some examples, the UE 115 may generate a channel estimation matrix Hᵢₙ based on the received signaling 460, and the projection 455 may include multiplying (e.g., matrix multiplication) Hᵢₙ and W1. Additionally, or alternatively, the projection 455 may involve a first ML model that determines the projection into a sub-space based on Hᵢₙ. W1 may be a parameter associated with channel projection onto a sub-space, where W1 includes vectors that make up the sub-space, as described herein. In some cases, the UE 115 may obtain a sub-space identity (ID) 470 from the projection 455 and may include the sub-space ID 470 in the channel state feedback 480. For example, the W1 value may be an example of the sub-space ID 470.

In some cases, the UE 115 may perform the projection 455 based on a first ML model (e.g., a neural network). For example, the UE 115 may determine W1 (e.g., based on the first ML model and a frequency range associated with a bandwidth size for channel projection), as described herein with respect to FIGS. 3 and 4A. In some cases, the UE 115 may perform the projection 455 on a sub-band basis. That is, the UE 115 may perform the projection 455 using different W1 values for different sub-bands of the channel bandwidth. For example, the UE 115 may perform the projection 455 using W1 on the frequency range 405 and may separately perform the projection 455 using W1 on the frequency range 410, where the frequency range 405 and the frequency range 410 are each sub-bands of another frequency range (e.g., the channel bandwidth, the bandwidth over which the signaling 460 was received).

Additionally, or alternatively, the UE 115 may perform a compression 465 as part of generating the channel state feedback 480. In some cases, the UE 115 may perform the compression 465 on the projected channel estimation matrix, Hᵢₙ. For example, the compression 465 may include performing an SVD on the projected Hᵢₙ (e.g., projected into the sub-space corresponding to the sub-space ID 470) to obtain a left singular vector U, a set of singular values S, and a right singular vector W2. In some examples, the UE 115 may obtain a compressed channel 475 from the compression 465 on the projected Hᵢₙ and may include the compressed channel 475 in the channel state feedback 480. In some cases, indicating the compressed channel 475 in the channel state feedback 480 may involve indicating U, S, W2, a compression of U, a compression of S, a compression of W2, or any combination thereof.

In some cases, the UE 115 may perform the compression 465 based on a second ML model, where the second ML model for the compression 465 may be different from the first ML model. For example, as described herein, the UE 115 may use W2 in the compression 465, and the UE may determine W2 based on the second ML model. In some cases, the UE 115 may perform the compression 465 on a sub-band basis, as described herein. For example, the UE 115 may perform the compression using W2 on the frequency range 415 and may separately perform the compression 465 on the frequency range 420, where the frequency range 415 and the frequency range 420 are sub-bands of the frequency range 405.

In some cases, the UE 115 may train the first ML model, the second ML model, or both over time and based on communications (e.g., signaling, channels) between the UE 115 and network entities 105. In some other cases, a network entity 105 or some other entity may train the first ML model, the second ML model, or both (e.g., in a lab environment, based on reported channel information across multiple UEs 115) and may deploy the trained model(s) to the UEs 115. In some cases, a UE 115 may receive a trained ML model (e.g., the first ML model, the second ML model) and may fine-tune the trained ML model specific to that UE 115. The UE 115 may supply channel information (e.g., channel estimation matrices), the bandwidth size 440, the bandwidth size 445, the received signaling 460, or any combination thereof to the first ML model, the second ML model, or both, as inputs. The UB 115 may determine W1 via the first ML model based on the inputs, and the UE 115 may determine W2 via the second ML model based on the inputs.

In some cases, the UE 115 may transmit the channel state feedback 480 to a network entity 105. In some cases, the channel state feedback 480 may include one or more aperiodic channel state feedback messages, one or more periodic channel feedback messages, one or more semi-persistent channel feedback messages, or any combination thereof. In some cases, the channel state feedback 480 may include the sub-space ID 470, the compressed channel 475, or both in a same message or in different messages.

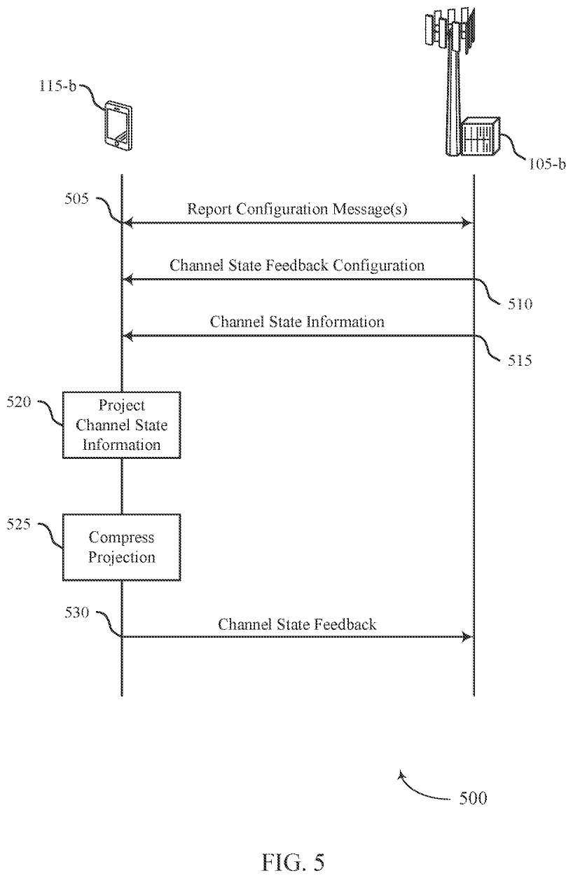

FIG. 5 shows an example of a process flow 500 that supports two-stage frequency domain ML-based channel state feedback in accordance with one or more aspects of the present disclosure. In some cases, aspects of the process flow 500 may implement or be implemented by aspects of a wireless communications system 100, a network architecture 200, or a wireless communications system 300 as described with reference to FIGS. 1 through 3. For example, the process flow 500 may include a UE 115-b and a network entity 105-b, which may be examples of a UE 115 and a network entity 105 as described herein with respect to FIGS. 1 through 4B. In some examples, the UE 115-b may communicate signaling with the network entity 105-b indicating one or more bandwidth sizes (e.g., frequency granularities) and may generate and transmit CSI feedback based on communicating the signaling.

In the following description of process flow 500, the operations may be performed in a different order than the order shown, or other operations may be added or removed from the process flow 500. For example, some operations may also be left out of process flow 500, may be performed in different orders or at different times, or other operations may be added to process flow 500. Although the UB 115-b and the network entity 105-b are shown performing the operations of process flow 500, some aspects of some operations may also be performed by one or more other wireless devices or network devices.

At 505, the UE 115-b may communicate one or more report configuration messages (e.g., first signaling) with the network entity 105-b. In some cases, the one or more report configuration messages may indicate a first bandwidth size and a second bandwidth size, where the second bandwidth size may be less than (e.g., smaller than) the first bandwidth size. Additionally, or alternatively, the first bandwidth size may correspond to a first ML model for channel projection, and the second bandwidth size may correspond to a second ML model for vector compression in a two-stage frequency domain ML-based channel state feedback procedure. In some cases, the first bandwidth size and the second bandwidth size may be examples of the bandwidth size 370 and the bandwidth size 375, respectively, the bandwidth size 440 and the bandwidth size 445, respectively, or both, as described herein with respect to FIGS. 3 and 4A. In some cases, the one or more report configuration messages may be examples of the report configuration 320, as described herein with respect to FIG. 3.

In some cases, communicating the one or more report configuration messages may include the UE 115-b receiving (e.g., from the network entity 105-b) configuration signaling indicating the first bandwidth size, the second bandwidth size, or both for a channel state feedback message. Additionally, or alternatively, communicating the one or more report configuration messages may include the UE 115-b transmitting a request (e.g., to the network entity 105-b) for the first bandwidth size, the second bandwidth size, or both and receiving, in response to the request, configuration signaling indicating the first bandwidth size, the second bandwidth size, or both for the channel state feedback message. Additionally, or alternatively, communicating the one or more report configuration messages may include the UE 115-b selecting (e.g., autonomously selecting, selecting based on one or more criteria) the first bandwidth size, the second bandwidth size, or both for the channel state feedback message and transmitting (e.g., to the network entity 105-b) an indication of the first bandwidth size, the second bandwidth size, or both based on the selection.

In some cases, the UE 115-b and the network entity 105-b may communicate the one or more report configuration messages based on a change in one or more channel metrics. For example, a frequency selectivity of a communication channel between the UE 115-b and the network entity 105-b may change, for example, due to a change in location of the UE 115-b. For example, the UE 115-b may move to a location where a relatively large obstacle (e.g., building, geographical feature) blocks a LoS between the UE 115-b and the network entity 105-b. In such an example, the frequency selectivity of a channel between the UE 115-b and the network entity 105-b may change, and the UE 115-b and network entity 105-b may communicate the one or more report configuration messages based on the change. Additionally, or alternatively, the UE 115-b may transmit a request (e.g., signaling requesting, to the network entity 105-b) for the network to update a resource allocation for the channel state feedback message based on the change in the one or more channel metrics. For example, if the frequency granularity changes for reporting channel state feedback, the UE 115-b may request additional resources to support transmitting additional CSI (e.g., at the new granularity level). Alternatively, the network entity 105-b may autonomously update a resource allocation for the UE 115-b for channel state feedback based on a change in frequency granularity for reporting.

In some cases, the UE 115-b may transmit (e.g., to the network entity 105-b) capability information for the UE 115-b. In some cases, the capability information may indicate that the UE 115-b supports (e.g., is capable of accessing, interfacing, or operating) the first ML model for channel projection, the second ML model for vector compression, different granularities for channel projection and vector compression, or any combination thereof. In some cases, the UE 115-b and the network entity 105-b may communicate the one or more report configuration messages based on the capability information for the UE 115-b. For example, if the capability information indicates that the UE 115-b does not support the first ML model, the second ML model, or both, the UE 115-b and the network entity 105-b may not communicate the one or more report configuration messages, or the one or more report configuration messages may not indicate the first bandwidth size, the second bandwidth size, or both.

At 510, the UE 115-b may receive signaling indicating a channel state feedback configuration. The channel state feedback configuration may be for transmitting the channel state feedback message. In some cases, the channel state feedback configuration may indicate resources for the channel state feedback, resources for receiving channel state information, or one or more types of channel state feedback messages (e.g., aperiodic messages, semi-persistent messages, periodic messages) and associated periodicities. In some cases, the signaling indicating the channel state feedback configuration may include an RRC message, a MAC-CE, or a DCI message.

At 515, the UE 115-b may receive (e.g., from the network entity 105-b) signaling indicating CSI. In some cases, the signaling may be an example of channel sounding, an SSB, a CSI-RS, or any other signaling indicating the channel.

At 520, the UE 115-b may project (e.g., perform a projection of) at least a portion of the received CSI. For example, the UE 115-b may project a portion of the received CSI that corresponds to (e.g., is received via) the first bandwidth size (e.g., a first frequency range having the first bandwidth size). Additionally, or alternatively, the UE 115-b may project the portion of the received CSI based on the first ML model. For example, the UE 115-b may project the portion of the received CSI onto a sub-space defined by W1 (e.g., the projection parameter), as described herein with respect to FIGS. 3 and 4B, where the UE 115-b may determine W1 via the first ML model. In some cases, W1 may define a sub-space of a codebook, where the codebook may be a non-DFT codebook of a set of codebooks. The non-DFT codebook, the set of codebooks, or both may be known to the UE 115-b, the network entity 105-b, or both.

At 525, the UE 115-b may compress at least a subset of the projected portion of the received CSI. For example, the UE 115-b may compress a subset of the projected portion of the received CSI that corresponds to (e.g., is received over) the second bandwidth size (e.g., a second frequency range having the second bandwidth size). Additionally, or alternatively, the UE 115-b may compress the subset of the projected portion of the received CSI based on the second ML model. For example, the UB 115-b may perform the compression based on W2, as described herein with respect to FIGS. 3 and 4B.

At 530, the UE 115-b may transmit the channel state feedback (e.g., one or more channel state feedback messages) based on the signaling received at 515. For example, the channel state feedback may indicate W1 (e.g., the sub-space of the codebook for the projection of at least the portion of the channel state information), a compression of the subset of the projected portion of the received CSI (e.g., W2), or both. In some cases, the indication of W1, W2, or both may be compressions of W1, W2, or both.

In some cases, as part of transmitting the channel state feedback, the UE 115-b may transmit an aperiodic channel state feedback message including a compression of W1 (e.g., indicating the sub-space of the codebook for the projection), a compression of W2 (e.g., indicating the compression of the subset of the projection), or both. In some cases, the UE 115-b may transmit the aperiodic channel state feedback message based on the channel state feedback configuration received at 510.

As described herein, the UE 115-b may receive channel state feedback configuration at 510. In some cases, the channel state feedback configuration may indicate a first periodicity and a second periodicity, where the second periodicity may be different (e.g., larger, less frequent) from the first periodicity. In such cases, the UE 115-b may transmit (e.g., periodically), as part of the channel state feedback, a first channel state feedback message (e.g., according to the first periodicity) including a compression of W1 and a second channel state feedback message (e.g., according to the second periodicity) including a compression of W2. In some cases, the first channel state feedback message, the second channel state feedback message, or both may be periodic messages, semi-persistent messages, or both.

In some cases, the channel state feedback message may include a first set of bits indicating the compression of W1 (e.g., approximately one hundred bits), a second set of bits indicating the compression of W2 (e.g., approximately ten bits or less), or both. In some cases, a first quantity of the first set of bits may be larger than a second quantity of the second set of bits, as described herein with respect to FIG. 3. In some cases, the network entity 105-b may update one or more characteristics of communications between the UE 115-b and the network entity 105-b based on the channel state feedback received from the UE 115-b.

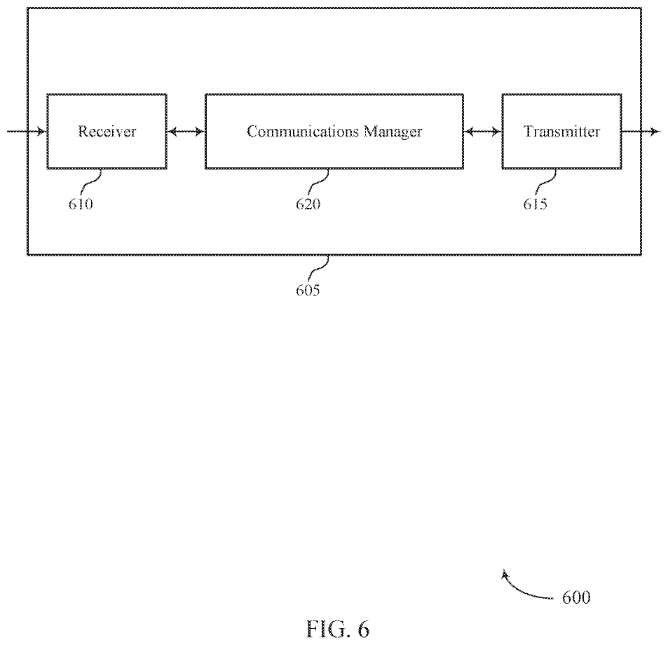

FIG. 6 shows a block diagram 600 of a device 605 that supports two-stage frequency domain ML-based channel state feedback in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to two-stage frequency domain ML-based channel state feedback). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to two-stage frequency domain ML-based channel state feedback). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of two-stage frequency domain ML-based channel state feedback as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 is capable of, configured to, or operable to support a means for communicating first signaling indicating a first bandwidth size and a second bandwidth size that is less than the first bandwidth size, the first bandwidth size corresponding to a first ML model for channel projection and the second bandwidth size corresponding to a second ML model for vector compression. The communications manager 620 is capable of, configured to, or operable to support a means for receiving second signaling indicating CSI. The communications manager 620 is capable of, configured to, or operable to support a means for transmitting a channel state feedback message based on the second signaling, the channel state feedback message indicating a sub-space of a codebook for a projection of at least a portion of the CSI corresponding to the first bandwidth size based on the first ML model (e.g., using W1), a compression of a subset of the projection corresponding to the second bandwidth size based on the second ML model (e.g., using W2), or both.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication and processing resources. For example, the device 605 implementing the techniques described herein may generate and transmit channel state feedback messages with relatively less frequency, may generate and transmit channel state feedback messages which include relatively fewer bits, or both. Accordingly, the device 605 may reduce communication and processing resources associated with channel state feedback.

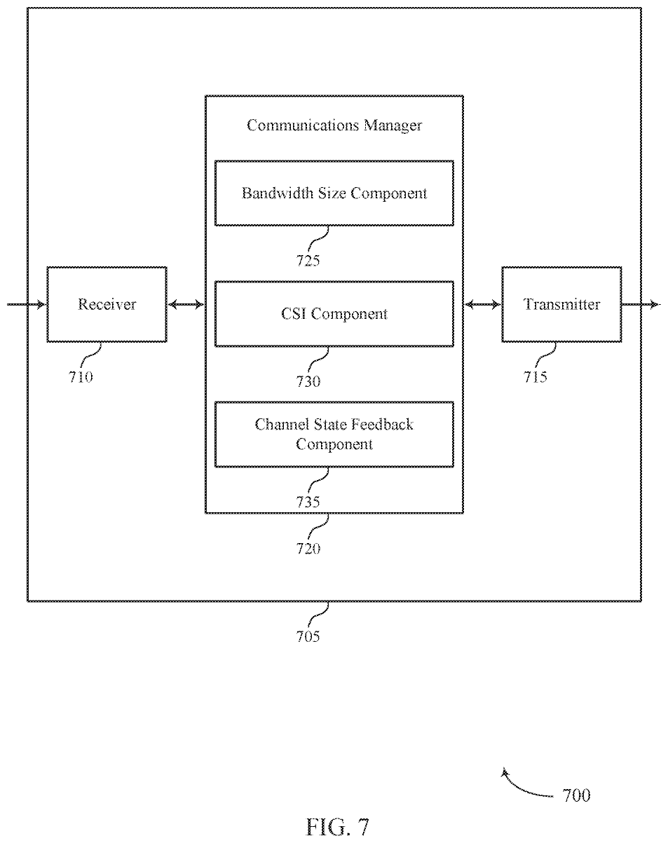

FIG. 7 shows a block diagram 700 of a device 705 that supports two-stage frequency domain ML-based channel state feedback in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to two-stage frequency domain ML-based channel state feedback). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to two-stage frequency domain ML-based channel state feedback). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of two-stage frequency domain ML-based channel state feedback as described herein. For example, the communications manager 720 may include a bandwidth size component 725, a CSI component 730, a channel state feedback component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The bandwidth size component 725 is capable of, configured to, or operable to support a means for communicating first signaling indicating a first bandwidth size and a second bandwidth size that is less than the first bandwidth size, the first bandwidth size corresponding to a first ML model for channel projection and the second bandwidth size corresponding to a second ML model for vector compression. The CSI component 730 is capable of, configured to, or operable to support a means for receiving second signaling indicating CSI. The channel state feedback component 735 is capable of, configured to, or operable to support a means for transmitting a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both.

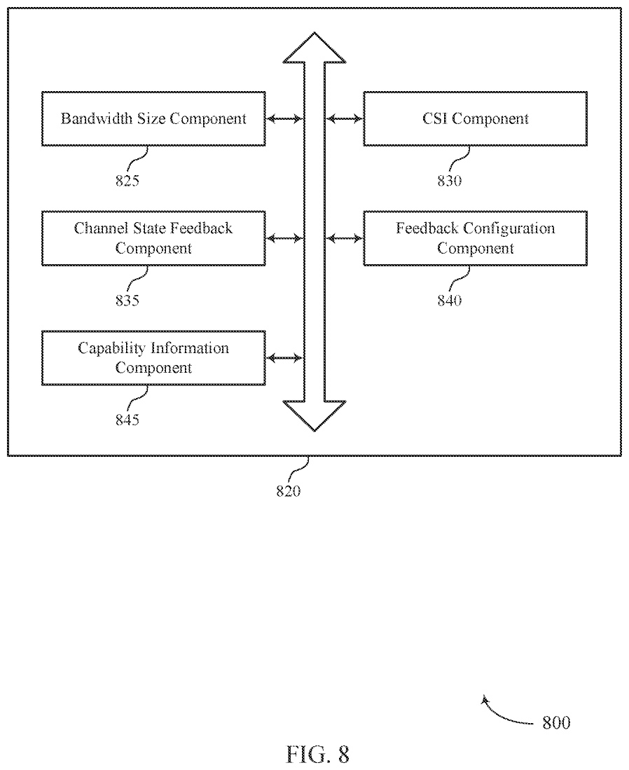

FIG. 8 shows a block diagram 800 of a communications manager 820 that supports two-stage frequency domain ML-based channel state feedback in accordance with one or more aspects of the present disclosure. The communications manager 820 may be an example of aspects of a communications manager 620, a communications manager 720, or both, as described herein. The communications manager 820, or various components thereof, may be an example of means for performing various aspects of two-stage frequency domain ML-based channel state feedback as described herein. For example, the communications manager 820 may include a bandwidth size component 825, a CSI component 830, a channel state feedback component 835, a feedback configuration component 840, a capability information component 845, or any combination thereof. Each of these components, or components or subcomponents thereof (e.g., one or more processors, one or more memories), may communicate, directly or indirectly, with one another (e.g., via one or more buses).

The bandwidth size component 825 is capable of, configured to, or operable to support a means for communicating first signaling indicating a first bandwidth size and a second bandwidth size that is less than the first bandwidth size, the first bandwidth size corresponding to a first ML model for channel projection and the second bandwidth size corresponding to a second ML model for vector compression. The CSI component 830 is capable of, configured to, or operable to support a means for receiving second signaling indicating CSI. The channel state feedback component 835 is capable of, configured to, or operable to support a means for transmitting a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both.

In some examples, to support communicating the first signaling, the bandwidth size component 825 is capable of, configured to, or operable to support a means for receiving configuration signaling indicating the first bandwidth size, the second bandwidth size, or both for the channel state feedback message.

In some examples, to support communicating the first signaling, the bandwidth size component 825 is capable of, configured to, or operable to support a means for transmitting a request for the first bandwidth size, the second bandwidth size, or both. In some examples, to support communicating the first signaling, the bandwidth size component 825 is capable of, configured to, or operable to support a means for receiving, in response to the request, configuration signaling indicating the first bandwidth size, the second bandwidth size, or both for the channel state feedback message.

In some examples, to support communicating the first signaling, the bandwidth size component 825 is capable of, configured to, or operable to support a means for selecting the first bandwidth size, the second bandwidth size, or both for the channel state feedback message. In some examples, to support communicating the first signaling, the bandwidth size component 825 is capable of, configured to, or operable to support a means for transmitting an indication of the first bandwidth size, the second bandwidth size, or both based on the selecting.

In some examples, communicating the first signaling is based on a change in one or more channel metrics.

In some examples, the feedback configuration component 840 is capable of, configured to, or operable to support a means for transmitting third signaling requesting an update to a resource allocation for the channel state feedback message based on the change in the one or more channel metrics.

In some examples, the feedback configuration component 840 is capable of, configured to, or operable to support a means for receiving third signaling indicating a configuration for transmitting the channel state feedback message, where transmitting the channel state feedback message is based on the configuration.

In some examples, to support transmitting the channel state feedback message, the channel state feedback component 835 is capable of, configured to, or operable to support a means for transmitting, based on the configuration, an aperiodic channel state feedback message including a first compression of a first parameter indicating the sub-space of the codebook for the projection, a second compression of a second parameter indicating the compression of the subset of the projection, or both.

In some examples, to support transmitting the channel state feedback message, the channel state feedback component 835 is capable of, configured to, or operable to support a means for transmitting, according to the first periodicity, a first channel state feedback message including a first compression of a first parameter indicating the sub-space of the codebook for the projection. In some examples, to support transmitting the channel state feedback message, the channel state feedback component 835 is capable of, configured to, or operable to support a means for transmitting, according to the second periodicity, a second channel state feedback message including a second compression of a second parameter indicating the compression of the subset of the projection.

In some examples, the third signaling includes a RRC message, a MAC control message, or a downlink control information message.

In some examples, the capability information component 845 is capable of, configured to, or operable to support a means for transmitting capability information for the UE indicating that the UE supports the first ML model for the channel projection and the second ML model for the vector compression, where communicating the first signaling is based on the capability information for the UE.

In some examples, the channel state feedback message includes a first set of bits indicating a first compression of a first parameter indicating the sub-space of the codebook for the projection, a second set of bits indicating a second compression of a second parameter indicating the compression of the subset of the projection, or both. In some examples, a first quantity of the first set of bits is larger than a second quantity of the second set of bits.

In some examples, the codebook includes a non-DFT codebook of a set of non-DFT codebooks.

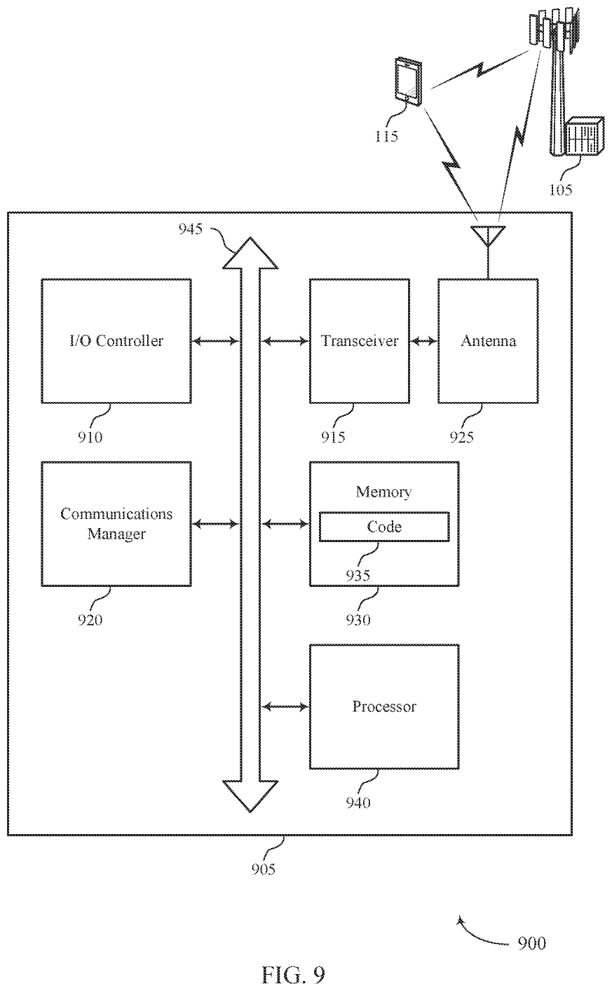

FIG. 9 shows a diagram of a system 900 including a device 905 that supports two-stage frequency domain ML-based channel state feedback in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting two-stage frequency domain ML-based channel state feedback). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

For example, the communications manager 920 is capable of, configured to, or operable to support a means for communicating first signaling indicating a first bandwidth size and a second bandwidth size that is less than the first bandwidth size, the first bandwidth size corresponding to a first ML model for channel projection and the second bandwidth size corresponding to a second ML model for vector compression. The communications manager 920 is capable of, configured to, or operable to support a means for receiving second signaling indicating CSI. The communications manager 920 is capable of, configured to, or operable to support a means for transmitting a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both.

By including or configuring the communications manager 920 in accordance with examples as described herein, the device 905 may support techniques for more efficient utilization of communication resources. For example, the device 905 implementing the techniques described herein may transmit channel state feedback messages with relatively less frequency, may transmit channel state feedback messages which include relatively fewer bits, or both. Thus, the device 905 may reduce the channel overhead and processing resources associated with channel state feedback.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of two-stage frequency domain ML-based channel state feedback as described herein, or the at least one processor 940 and the at least one memory 930 may be otherwise configured to, individually or collectively, perform or support such operations.

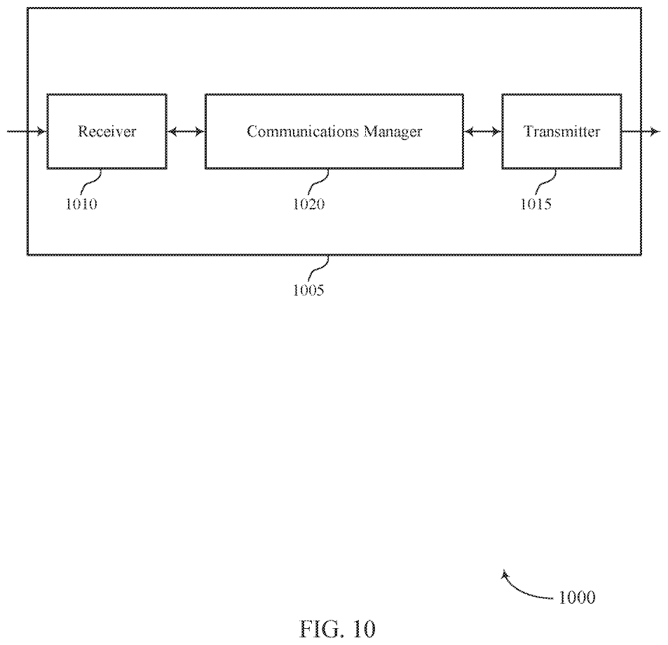

FIG. 10 shows a block diagram 1000 of a device 1005 that supports two-stage frequency domain ML-based channel state feedback in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of two-stage frequency domain ML-based channel state feedback as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

For example, the communications manager 1020 is capable of, configured to, or operable to support a means for communicating first signaling indicating a first bandwidth size and a second bandwidth size that is less than the first bandwidth size, the first bandwidth size corresponding to a first ML model for channel projection and the second bandwidth size corresponding to a second ML model for vector compression. The communications manager 1020 is capable of, configured to, or operable to support a means for transmitting, for a UE, second signaling indicating CSI. The communications manager 1020 is capable of, configured to, or operable to support a means for receiving a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication and processing resources. For example, the device 1005 implementing the techniques described herein may receive and process channel state feedback messages with relatively less frequency, may receive and process channel state feedback messages which include relatively fewer bits, or both. Thus, the device 1005 may utilize relatively fewer communication and processing resources.

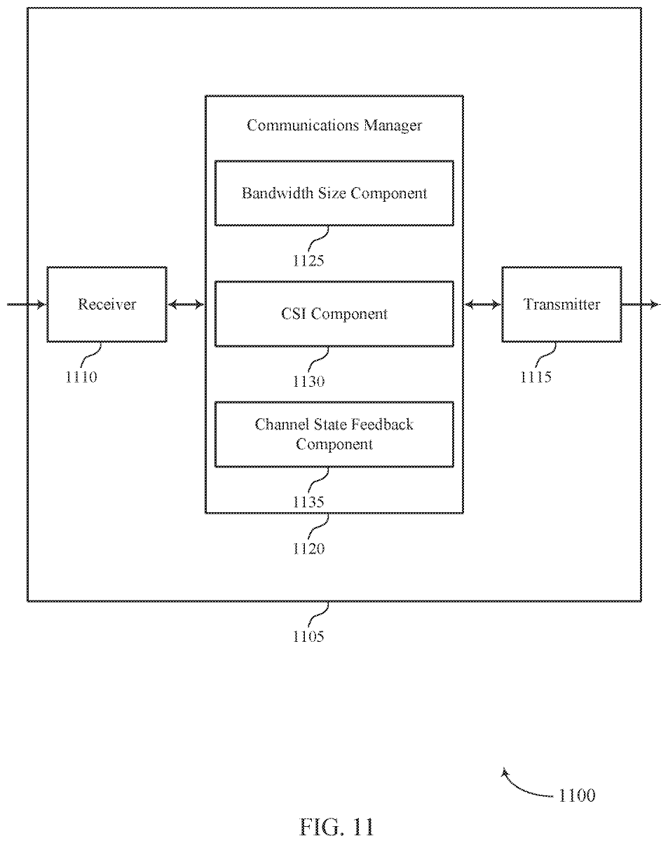

FIG. 11 shows a block diagram 1100 of a device 1105 that supports two-stage frequency domain ML-based channel state feedback in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of two-stage frequency domain ML-based channel state feedback as described herein. For example, the communications manager 1120 may include a bandwidth size component 1125, a CSI component 1130, a channel state feedback component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The bandwidth size component 1125 is capable of, configured to, or operable to support a means for communicating first signaling indicating a first bandwidth size and a second bandwidth size that is less than the first bandwidth size, the first bandwidth size corresponding to a first ML model for channel projection and the second bandwidth size corresponding to a second ML model for vector compression. The CSI component 1130 is capable of, configured to, or operable to support a means for transmitting, for a UE, second signaling indicating CSI. The channel state feedback component 1135 is capable of, configured to, or operable to support a means for receiving a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both.

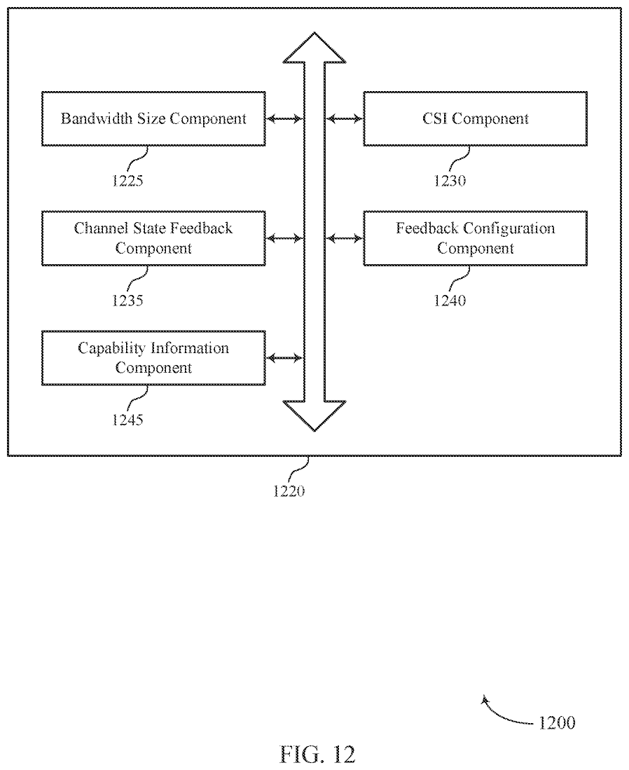

FIG. 12 shows a block diagram 1200 of a communications manager 1220 that supports two-stage frequency domain ML-based channel state feedback in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of two-stage frequency domain ML-based channel state feedback as described herein. For example, the communications manager 1220 may include a bandwidth size component 1225, a CSI component 1230, a channel state feedback component 1235, a feedback configuration component 1240, a capability information component 1245, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The bandwidth size component 1225 is capable of, configured to, or operable to support a means for communicating first signaling indicating a first bandwidth size and a second bandwidth size that is less than the first bandwidth size, the first bandwidth size corresponding to a first ML model for channel projection and the second bandwidth size corresponding to a second ML model for vector compression. The CSI component 1230 is capable of, configured to, or operable to support a means for transmitting, for a UE, second signaling indicating CSI. The channel state feedback component 1235 is capable of, configured to, or operable to support a means for receiving a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both.

In some examples, to support communicating the first signaling, the bandwidth size component 1225 is capable of, configured to, or operable to support a means for transmitting configuration signaling indicating the first bandwidth size, the second bandwidth size, or both for the channel state feedback message.

In some examples, to support communicating the first signaling, the bandwidth size component 1225 is capable of, configured to, or operable to support a means for receiving a request for the first bandwidth size, the second bandwidth size, or both. In some examples, to support communicating the first signaling, the bandwidth size component 1225 is capable of, configured to, or operable to support a means for transmitting, in response to the request, configuration signaling indicating the first bandwidth size, the second bandwidth size, or both for the channel state feedback message.

In some examples, to support communicating the first signaling, the bandwidth size component 1225 is capable of, configured to, or operable to support a means for receiving an indication of the first bandwidth size, the second bandwidth size, or both used for the channel state feedback message.

In some examples, communicating the first signaling is based on a change in one or more channel metrics for the UE.

In some examples, the feedback configuration component 1240 is capable of, configured to, or operable to support a means for transmitting third signaling updating a resource allocation for the channel state feedback message based on the change in the one or more channel metrics.

In some examples, the feedback configuration component 1240 is capable of, configured to, or operable to support a means for receiving fourth signaling requesting an update to the resource allocation for the channel state feedback message, where transmitting the third signaling updating the resource allocation is further based on the fourth signaling.

In some examples, the feedback configuration component 1240 is capable of, configured to, or operable to support a means for transmitting third signaling indicating a configuration for transmitting the channel state feedback message, where receiving the channel state feedback message is based on the configuration.

In some examples, to support receiving the channel state feedback message, the channel state feedback component 1235 is capable of, configured to, or operable to support a means for receiving, based on the configuration, an aperiodic channel state feedback message including a first compression of a first parameter indicating the sub-space of the codebook for the projection, a second compression of a second parameter indicating the compression of the subset of the projection, or both.

In some examples, to support receiving the channel state feedback message, the channel state feedback component 1235 is capable of, configured to, or operable to support a means for receiving, according to the first periodicity, a first channel state feedback message including a first parameter indicating the sub-space of the codebook for the projection. In some examples, to support receiving the channel state feedback message, the channel state feedback component 1235 is capable of, configured to, or operable to support a means for receiving, according to the second periodicity, a second channel state feedback message including a second compression of a second parameter indicating the compression of the subset of the projection.

In some examples, the third signaling includes a RRC message, a MAC control message, or a downlink control information message.

In some examples, the capability information component 1245 is capable of, configured to, or operable to support a means for receiving capability information for the UE indicating that the UE supports the first ML model for the channel projection and the second ML model for the vector compression, where communicating the first signaling is based on the capability information for the UE.

In some examples, the channel state feedback message includes a first set of bits indicating a first compression of a first parameter indicating the sub-space of the codebook for the projection, a second set of bits indicating a second compression of a second parameter indicating the compression of the subset of the projection, or both. In some examples, a first quantity of the first set of bits is larger than a second quantity of the second set of bits.

In some examples, the codebook includes a non-DFT codebook of a set of non-DFT codebooks.

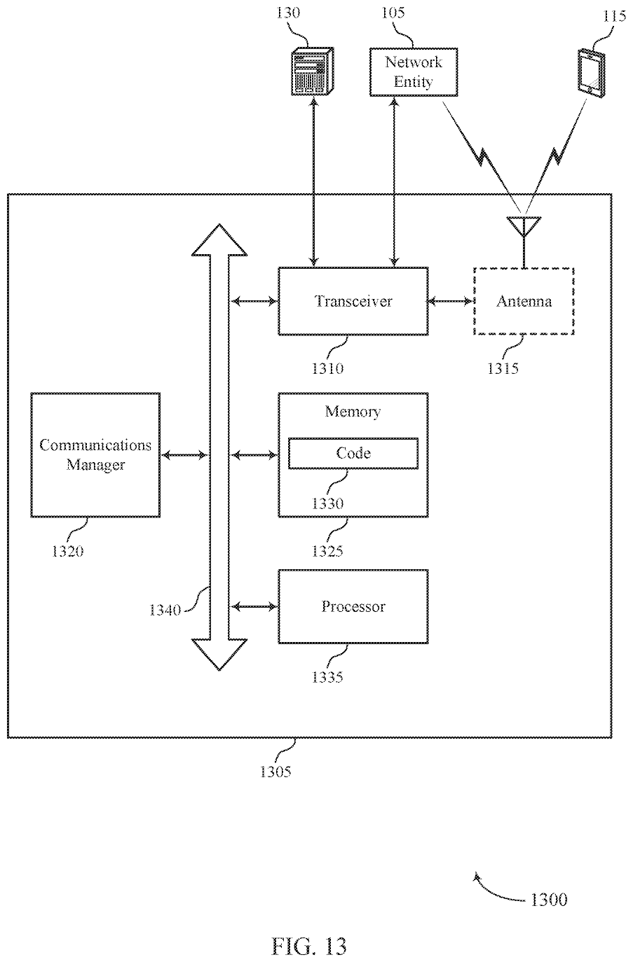

FIG. 13 shows a diagram of a system 1300 including a device 1305 that supports two-stage frequency domain ML-based channel state feedback in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting two-stage frequency domain ML-based channel state feedback). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. As such, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

For example, the communications manager 1320 is capable of, configured to, or operable to support a means for communicating first signaling indicating a first bandwidth size and a second bandwidth size that is less than the first bandwidth size, the first bandwidth size corresponding to a first ML model for channel projection and the second bandwidth size corresponding to a second ML model for vector compression. The communications manager 1320 is capable of, configured to, or operable to support a means for transmitting, for a UE, second signaling indicating CSI. The communications manager 1320 is capable of, configured to, or operable to support a means for receiving a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both.

By including or configuring the communications manager 1320 in accordance with examples as described herein, the device 1305 may support techniques for more efficient utilization of communication resources. For example, the device 1305 implementing the techniques described herein may receive channel state feedback messages with relatively less frequency, may receive channel state feedback messages which include relatively fewer bits, or both. Thus, the device 1305 may utilize relatively fewer communication and processing resources for channel state feedback procedures.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of two-stage frequency domain ML-based channel state feedback as described herein, or the at least one processor 1335 and the at least one memory 1325 may be otherwise configured to, individually or collectively, perform or support such operations.

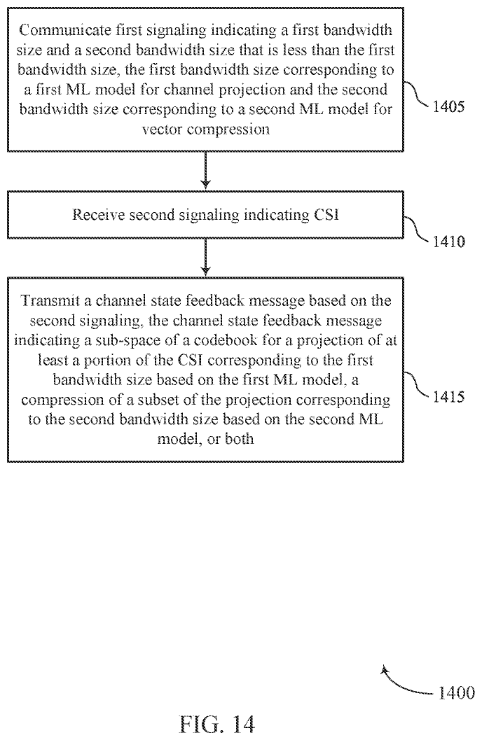

FIG. 14 shows a flowchart illustrating a method 1400 that supports two-stage frequency domain ML-based channel state feedback in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include communicating first signaling indicating a first bandwidth size and a second bandwidth size that is less than the first bandwidth size, the first bandwidth size corresponding to a first ML model for channel projection and the second bandwidth size corresponding to a second ML model for vector compression. The operations of block 1405 may be performed in accordance with examples as disclosed herein. In some examples, aspects of the operations of 1405 may be performed by a bandwidth size component 825 as described with reference to FIG. 8.

At 1410, the method may include receiving second signaling indicating CSI. The operations of block 1410 may be performed in accordance with examples as disclosed herein. In some examples, aspects of the operations of 1410 may be performed by a CSI component 830 as described with reference to FIG. 8.

At 1415, the method may include transmitting a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both. The operations of block 1415 may be performed in accordance with examples as disclosed herein. In some examples, aspects of the operations of 1415 may be performed by a channel state feedback component 835 as described with reference to FIG. 8.

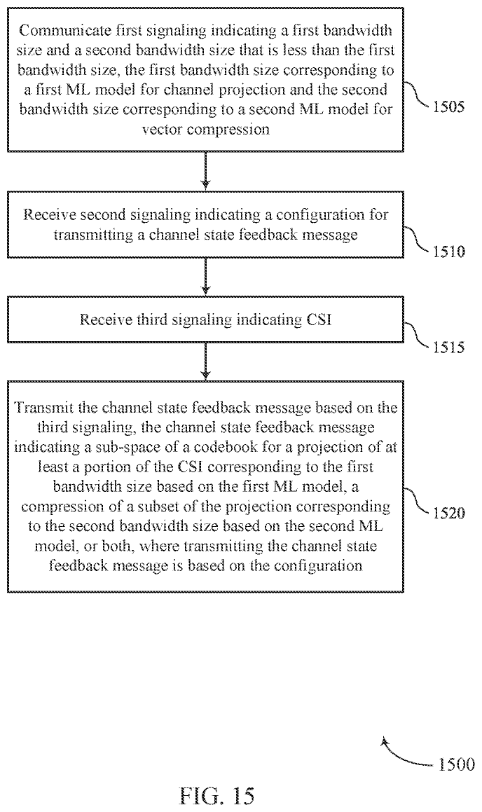

FIG. 15 shows a flowchart illustrating a method 1500 that supports two-stage frequency domain ML-based channel state feedback in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include communicating first signaling indicating a first bandwidth size and a second bandwidth size that is less than the first bandwidth size, the first bandwidth size corresponding to a first ML model for channel projection and the second bandwidth size corresponding to a second ML model for vector compression. The operations of block 1505 may be performed in accordance with examples as disclosed herein. In some examples, aspects of the operations of 1505 may be performed by a bandwidth size component 825 as described with reference to FIG. 8.

At 1510, the method may include receiving second signaling indicating a configuration for transmitting a channel state feedback message. The operations of block 1510 may be performed in accordance with examples as disclosed herein. In some examples, aspects of the operations of 1510 may be performed by a feedback configuration component 840 as described with reference to FIG. 8.

At 1515, the method may include receiving third signaling indicating CSI. The operations of block 1515 may be performed in accordance with examples as disclosed herein. In some examples, aspects of the operations of 1515 may be performed by a CSI component 830 as described with reference to FIG. 8.

At 1520, the method may include transmitting the channel state feedback message based on the third signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both, where transmitting the channel state feedback message is based on the configuration (e.g., the configuration indicated by the third signaling). The operations of block 1520 may be performed in accordance with examples as disclosed herein. In some examples, aspects of the operations of 1520 may be performed by a channel state feedback component 835 as described with reference to FIG. 8.

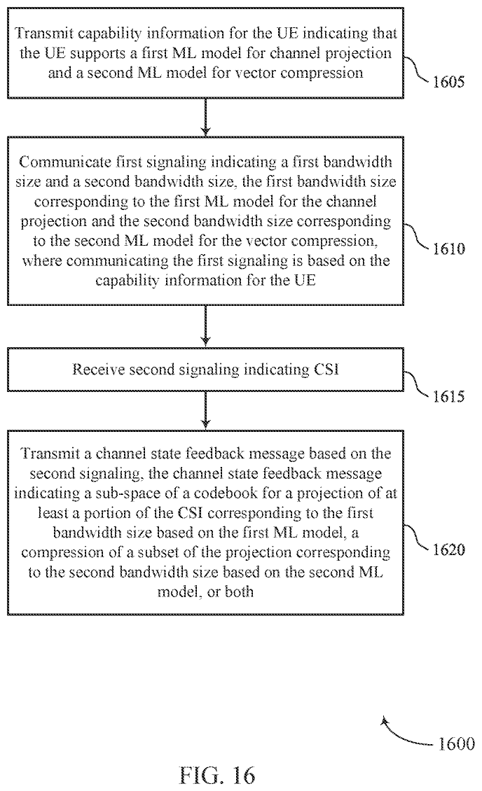

FIG. 16 shows a flowchart illustrating a method 1600 that supports two-stage frequency domain ML-based channel state feedback in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include transmitting capability information for the UE indicating that the UE supports a first ML model for channel projection and a second ML model for vector compression. The operations of block 1605 may be performed in accordance with examples as disclosed herein. In some examples, aspects of the operations of 1605 may be performed by a capability information component 845 as described with reference to FIG. 8.

At 1610, the method may include communicating first signaling indicating a first bandwidth size and a second bandwidth size that is less than the first bandwidth size, the first bandwidth size corresponding to the first ML model for the channel projection and the second bandwidth size corresponding to the second ML model for the vector compression, where communicating the first signaling is based on the capability information for the UE. The operations of block 1610 may be performed in accordance with examples as disclosed herein. In some examples, aspects of the operations of 1610 may be performed by a bandwidth size component 825 as described with reference to FIG. 8.

At 1615, the method may include receiving second signaling indicating CSI. The operations of block 1615 may be performed in accordance with examples as disclosed herein. In some examples, aspects of the operations of 1615 may be performed by a CSI component 830 as described with reference to FIG. 8.

At 1620, the method may include transmitting a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both. The operations of block 1620 may be performed in accordance with examples as disclosed herein. In some examples, aspects of the operations of 1620 may be performed by a channel state feedback component 835 as described with reference to FIG. 8.

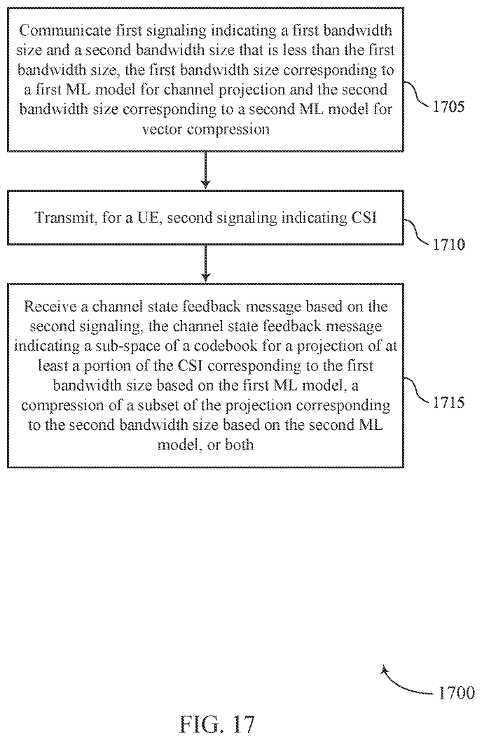

FIG. 17 shows a flowchart illustrating a method 1700 that supports two-stage frequency domain ML-based channel state feedback in accordance with aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include communicating first signaling indicating a first bandwidth size and a second bandwidth size that is less than the first bandwidth size, the first bandwidth size corresponding to a first ML model for channel projection and the second bandwidth size corresponding to a second ML model for vector compression. The operations of block 1705 may be performed in accordance with examples as disclosed herein. In some examples, aspects of the operations of 1705 may be performed by a bandwidth size component 1225 as described with reference to FIG. 12.

At 1710, the method may include transmitting, for a UE, second signaling indicating CSI. The operations of block 1710 may be performed in accordance with examples as disclosed herein. In some examples, aspects of the operations of 1710 may be performed by a CSI component 1230 as described with reference to FIG. 12.

At 1715, the method may include receiving a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both. The operations of block 1715 may be performed in accordance with examples as disclosed herein. In some examples, aspects of the operations of 1715 may be performed by a channel state feedback component 1235 as described with reference to FIG. 12.

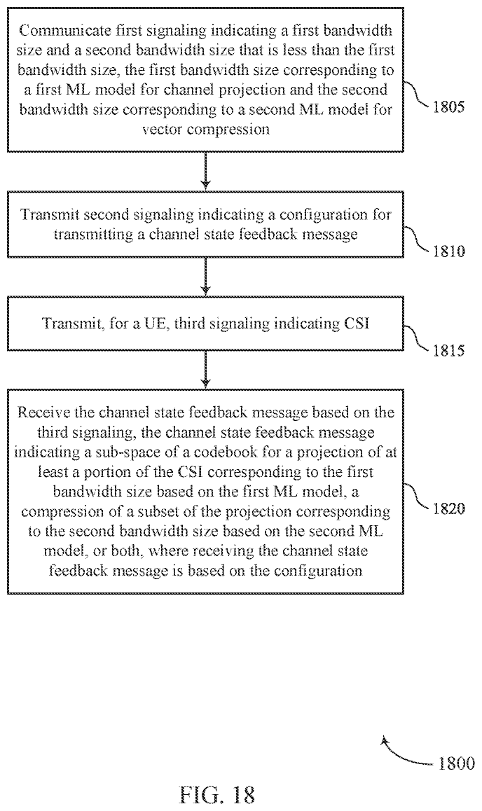

FIG. 18 shows a flowchart illustrating a method 1800 that supports two-stage frequency domain ML-based channel state feedback in accordance with aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include communicating first signaling indicating a first bandwidth size and a second bandwidth size that is less than the first bandwidth size, the first bandwidth size corresponding to a first ML model for channel projection and the second bandwidth size corresponding to a second ML model for vector compression. The operations of block 1805 may be performed in accordance with examples as disclosed herein. In some examples, aspects of the operations of 1805 may be performed by a bandwidth size component 1225 as described with reference to FIG. 12.

At 1810, the method may include transmitting second signaling indicating a configuration for transmitting a channel state feedback message. The operations of block 1810 may be performed in accordance with examples as disclosed herein. In some examples, aspects of the operations of 1810 may be performed by a feedback configuration component 1240 as described with reference to FIG. 12.

At 1815, the method may include transmitting, for a UE, third signaling indicating CSI. The operations of block 1815 may be performed in accordance with examples as disclosed herein. In some examples, aspects of the operations of 1815 may be performed by a CSI component 1230 as described with reference to FIG. 12.

At 1820, the method may include receiving the channel state feedback message based on the third signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both, where receiving the channel state feedback message is based on the configuration (e.g., the configuration indicated by u the third signaling). The operations of block 1820 may be performed in accordance with examples as disclosed herein. In some examples, aspects of the operations of 1820 may be performed by a channel state feedback component 1235 as described with reference to FIG. 12.

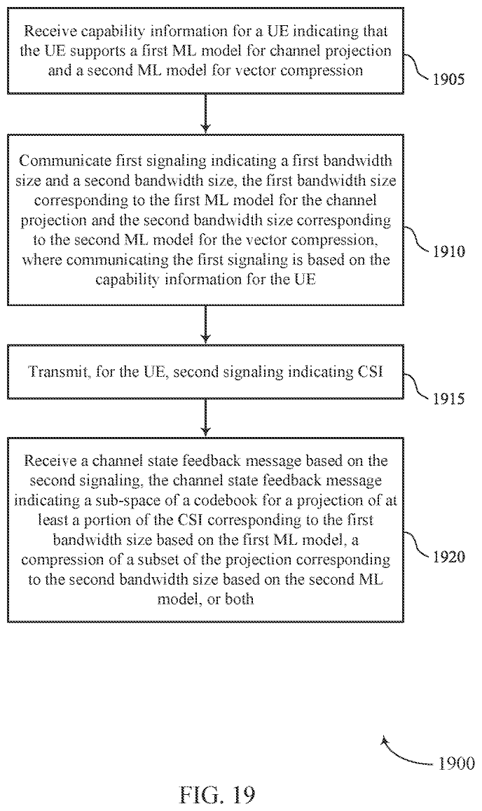

FIG. 19 shows a flowchart illustrating a method 1900 that supports two-stage frequency domain ML-based channel state feedback in accordance with aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include receiving capability information for the UE indicating that the UE supports a first ML model for channel projection and a second ML model for vector compression. The operations of block 1905 may be performed in accordance with examples as disclosed herein. In some examples, aspects of the operations of 1905 may be performed by a capability information component 1245 as described with reference to FIG. 12.

At 1910, the method may include communicating first signaling indicating a first bandwidth size and a second bandwidth size that is less than the first bandwidth size, the first bandwidth size corresponding to the first ML model for the channel projection and the second bandwidth size corresponding to the second ML model for the vector compression, where communicating the first signaling is based on the capability information for the UE. The operations of block 1910 may be performed in accordance with examples as disclosed herein. In some examples, aspects of the operations of 1910 may be performed by a bandwidth size component 1225 as described with reference to FIG. 12.

At 1915, the method may include transmitting, for a UE, second signaling indicating CSI. The operations of block 1915 may be performed in accordance with examples as disclosed herein. In some examples, aspects of the operations of 1915 may be performed by a CSI component 1230 as described with reference to FIG. 12.

At 1920, the method may include receiving a channel state feedback message based on the second signaling, the channel state feedback message indicating a sub-space of a codebook for a projection of at least a portion of the CSI corresponding to the first bandwidth size based on the first ML model, a compression of a subset of the projection corresponding to the second bandwidth size based on the second ML model, or both. The operations of block 1920 may be performed in accordance with examples as disclosed herein. In some examples, aspects of the operations of 1920 may be performed by a channel state feedback component 1235 as described with reference to FIG. 12.

The following provides an overview of aspects of the present disclosure:
Aspect 1: A method for wireless communications at a UE, comprising: communicating first signaling indicating a first bandwidth size and a second bandwidth size that is less than the first bandwidth size, the first bandwidth size corresponding to a first ML model for channel projection and the second bandwidth size corresponding to a second ML model for vector compression; receiving second signaling indicating CSI; and transmitting a channel state feedback message based at least in part on the second signaling, the channel state feedback message indicating a sub-space of a codebook for a projection of at least a portion of the CSI corresponding to the first bandwidth size based at least in part on the first ML model, a compression of a subset of the projection corresponding to the second bandwidth size based at least in part on the second ML model, or both.
Aspect 2: The method of aspect 1, wherein communicating the first signaling comprises: receiving configuration signaling indicating the first bandwidth size, the second bandwidth size, or both for the channel state feedback message.
Aspect 3: The method of any of aspects 1 through 2, wherein communicating the first signaling comprises: transmitting a request for the first bandwidth size, the second bandwidth size, or both; and receiving, in response to the request, configuration signaling indicating the first bandwidth size, the second bandwidth size, or both for the channel state feedback message.
Aspect 4: The method of aspect 1, wherein communicating the first signaling comprises: selecting the first bandwidth size, the second bandwidth size, or both for the channel state feedback message; and transmitting an indication of the first bandwidth size, the second bandwidth size, or both based at least in part on the selecting.
Aspect 5: The method of any of aspects 1 through 4, wherein communicating the first signaling is based at least in part on a change in one or more channel metrics.
Aspect 6: The method of aspect 5, further comprising: transmitting third signaling requesting an update to a resource allocation for the channel state feedback message based at least in part on the change in the one or more channel metrics.
Aspect 7: The method of any of aspects 1 through 6, further comprising: receiving third signaling indicating a configuration for transmitting the channel state feedback message, wherein transmitting the channel state feedback message is based at least in part on the configuration.
Aspect 8: The method of aspect 7, wherein transmitting the channel state feedback message comprises: transmitting, based at least in part on the configuration, an aperiodic channel state feedback message comprising a first compression of a first parameter indicating the sub-space of the codebook for the projection, a second compression of a second parameter indicating the compression of the subset of the projection, or both.
Aspect 9: The method of aspect 7, wherein the configuration indicates a first periodicity and a second periodicity different from the first periodicity, and wherein transmitting the channel state feedback message comprises: transmitting, according to the first periodicity, a first channel state feedback message comprising a first compression of a first parameter indicating the sub-space of the codebook for the projection; and transmitting, according to the second periodicity, a second channel state feedback message comprising a second compression of a second parameter indicating the compression of the subset of the projection.
Aspect 10: The method of any of aspects 7 through 9, wherein the third signaling comprises an RRC message, a MAC control message, or a DCI message.
Aspect 11: The method of any of aspects 1 through 10, further comprising: transmitting capability information for the UE indicating that the UE supports the first ML model for the channel projection and the second ML model for the vector compression, wherein communicating the first signaling is based at least in part on the capability information for the UE.
Aspect 12: The method of any of aspects 1 through 11, wherein the channel state feedback message comprises a first set of bits indicating a first compression of a first parameter indicating the sub-space of the codebook for the projection, a second set of bits indicating a second compression of a second parameter indicating the compression of the subset of the projection, or both; and a first quantity of the first set of bits is larger than a second quantity of the second set of bits.
Aspect 13: The method of any of aspects 1 through 12, wherein the codebook comprises a non-DFT codebook of a set of non-DFT codebooks.
Aspect 14: A method for wireless communications at a network entity, comprising: communicating first signaling indicating a first bandwidth size and a second bandwidth size that is less than the first bandwidth size, the first bandwidth size corresponding to a first ML model for channel projection and the second bandwidth size corresponding to a second ML model for vector compression; transmitting, for a UE, second signaling indicating CSI; and receiving a channel state feedback message based at least in part on the second signaling, the channel state feedback message indicating a sub-space of a codebook for a projection of at least a portion of the CSI corresponding to the first bandwidth size based at least in part on the first ML model, a compression of a subset of the projection corresponding to the second bandwidth size based at least in part on the second ML model, or both.
Aspect 15: The method of aspect 14, wherein communicating the first signaling comprises: transmitting configuration signaling indicating the first bandwidth size, the second bandwidth size, or both for the channel state feedback message.
Aspect 16: The method of any of aspects 14 through 15, wherein communicating the first signaling comprises: receiving a request for the first bandwidth size, the second bandwidth size, or both; and transmitting, in response to the request, configuration signaling indicating the first bandwidth size, the second bandwidth size, or both for the channel state feedback message.
Aspect 17: The method of aspect 16, wherein communicating the first signaling comprises: receiving an indication of the first bandwidth size, the second bandwidth size, or both used for the channel state feedback message.
Aspect 18: The method of any of aspects 14 through 17, wherein communicating the first signaling is based at least in part on a change in one or more channel metrics for the UE.
Aspect 19: The method of aspect 18, further comprising: transmitting third signaling updating a resource allocation for the channel state feedback message based at least in part on the change in the one or more channel metrics.
Aspect 20: The method of aspect 19, further comprising: receiving fourth signaling requesting an update to the resource allocation for the channel state feedback message, wherein transmitting the third signaling updating the resource allocation is further based at least in part on the fourth signaling.
Aspect 21: The method of any of aspects 14 through 20, further comprising: transmitting third signaling indicating a configuration for transmitting the channel state feedback message, wherein receiving the channel state feedback message is based at least in part on the configuration.
Aspect 22: The method of aspect 21, wherein receiving the channel state feedback message comprises: receiving, based at least in part on the configuration, an aperiodic channel state feedback message comprising a first compression of a first parameter indicating the sub-space of the codebook for the projection, a second compression of a second parameter indicating the compression of the subset of the projection, or both.
Aspect 23: The method of aspect 21, wherein the configuration indicates a first periodicity and a second periodicity different from the first periodicity, and wherein receiving the channel state feedback message comprises: receiving, according to the first periodicity, a first channel state feedback message comprising a first parameter indicating the sub-space of the codebook for the projection; and receiving, according to the second periodicity, a second channel state feedback message comprising a second compression of a second parameter indicating the compression of the subset of the projection.
Aspect 24: The method of any of aspects 21 through 23, wherein the third signaling comprises an RRC message, a MAC control message, or a DCI message.
Aspect 25: The method of any of aspects 14 through 24, further comprising: receiving capability information for the UE indicating that the UE supports the first ML model for the channel projection and the second ML model for the vector compression, wherein communicating the first signaling is based at least in part on the capability information for the UE.
Aspect 26: The method of any of aspects 14 through 25, wherein the channel state feedback message comprises a first set of bits indicating a first compression of a first parameter indicating the sub-space of the codebook for the projection, a second set of bits indicating a second compression of a second parameter indicating the compression of the subset of the projection, or both; and a first quantity of the first set of bits is larger than a second quantity of the second set of bits.
Aspect 27: The method of any of aspects 14 through 26, wherein the codebook comprises a non-DFT codebook of a set of non-DFT codebooks.
Aspect 28: A UE comprising one or more memories and one or more processors coupled with the one or more memories and individually or collectively configured to perform a method of any of aspects 1 through 13.
Aspect 29: A UE comprising at least one means for performing a method of any of aspects 1 through 13.
Aspect 30: A non-transitory computer-readable medium storing code the code comprising instructions executable by a processor to perform a method of any of aspects 1 through 13.
Aspect 31: A network entity comprising one or more memories and one or more processors coupled with the one or more memories and individually or collectively configured to perform a method of any of aspects 14 through 27.
Aspect 32: A network entity comprising at least one means for performing a method of any of aspects 14 through 27.
Aspect 33: A non-transitory computer-readable medium storing code the code comprising instructions executable by a processor to perform a method of any of aspects 14 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions of operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories; and
one or more processors coupled with the one or more memories and individually or collectively configured to:
communicate first signaling indicating a first bandwidth size and a second bandwidth size that is less than the first bandwidth size, the first bandwidth size corresponding to a first machine learning model for channel projection and the second bandwidth size corresponding to a second machine learning model for vector compression;
receive second signaling indicating channel state information; and
transmit a channel state feedback message based at least in part on the second signaling, the channel state feedback message indicating a sub-space of a codebook for a projection of at least a portion of the channel state information corresponding to the first bandwidth size based at least in part on the first machine learning model, a compression of a subset of the projection corresponding to the second bandwidth size based at least in part on the second machine learning model, or both.

2. The UE of claim 1, wherein, to communicate the first signaling, the one or more processors are individually or collectively configured to:
receive configuration signaling indicating the first bandwidth size, the second bandwidth size, or both for the channel state feedback message.

3. The UE of claim 1, wherein, to communicate the first signaling, the one or more processors are individually or collectively configured to:
transmit a request for the first bandwidth size, the second bandwidth size, or both; and
receive, in response to the request, configuration signaling indicating the first bandwidth size, the second bandwidth size, or both for the channel state feedback message.

4. The UE of claim 1, wherein, to communicate the first signaling, the one or more processors are individually or collectively configured to:
select the first bandwidth size, the second bandwidth size, or both for the channel state feedback message; and
transmit an indication of the first bandwidth size, the second bandwidth size, or both based at least in part on the selecting.

5. The UE of claim 1, wherein communicating the first signaling is based at least in part on a change in one or more channel metrics.

6. The UE of claim 5, wherein the one or more processors are individually or collectively further configured to:
transmit third signaling requesting an update to a resource allocation for the channel state feedback message based at least in part on the change in the one or more channel metrics.

7. The UE of claim 1, wherein the one or more processors are individually or collectively further configured to:
receive third signaling indicating a configuration for transmitting the channel state feedback message, wherein transmitting the channel state feedback message is based at least in part on the configuration.

8. The UE of claim 7, wherein, to transmit the channel state feedback message, the one or more processors are individually or collectively configured to:
transmit, based at least in part on the configuration, an aperiodic channel state feedback message comprising a first compression of a first parameter indicating the sub-space of the codebook for the projection, a second compression of a second parameter indicating the compression of the subset of the projection, or both.

9. The UE of claim 7, wherein the configuration indicates a first periodicity and a second periodicity different from the first periodicity, and wherein, to transmit the channel state feedback message, the one or more processors are individually or collectively configured to:
transmit, according to the first periodicity, a first channel state feedback message comprising a first compression of a first parameter indicating the sub-space of the codebook for the projection; and
transmit, according to the second periodicity, a second channel state feedback message comprising a second compression of a second parameter indicating the compression of the subset of the projection.

10. The UE of claim 7, wherein the third signaling comprises a radio resource control message, a medium access control control message, or a downlink control information message.

11. The UE of claim 1, wherein the one or more processors are individually or collectively further configured to:
transmit capability information for the UE indicating that the UE supports the first machine learning model for the channel projection and the second machine learning model for the vector compression, wherein communicating the first signaling is based at least in part on the capability information for the UE.

12. The UE of claim 1, wherein:
the channel state feedback message comprises a first set of bits indicating a first compression of a first parameter indicating the sub-space of the codebook for the projection, a second set of bits indicating a second compression of a second parameter indicating the compression of the subset of the projection, or both; and
a first quantity of the first set of bits is larger than a second quantity of the second set of bits.

13. The UE of claim 1, wherein the codebook comprises a non-discrete Fourier transform codebook of a set of non-discrete Fourier transform codebooks.

14. A network entity, comprising:
one or more memories; and
one or more processors coupled with the one or more memories and individually or collectively configured to:
communicate first signaling indicating a first bandwidth size and a second bandwidth size that is less than the first bandwidth size, the first bandwidth size corresponding to a first machine learning model for channel projection and the second bandwidth size corresponding to a second machine learning model for vector compression;
transmit, for a user equipment (UE), second signaling indicating channel state information; and
receive a channel state feedback message based at least in part on the second signaling, the channel state feedback message indicating a sub-space of a codebook for a projection of at least a portion of the channel state information corresponding to the first bandwidth size based at least in part on the first machine learning model, a compression of a subset of the projection corresponding to the second bandwidth size based at least in part on the second machine learning model, or both.

15. The network entity of claim 14, wherein, to communicate the first signaling, the one or more processors are individually or collectively configured to:
transmit configuration signaling indicating the first bandwidth size, the second bandwidth size, or both for the channel state feedback message.

16. The network entity of claim 14, wherein, to communicate the first signaling, the one or more processors are individually or collectively configured to:
receive a request for the first bandwidth size, the second bandwidth size, or both; and
transmit, in response to the request, configuration signaling indicating the first bandwidth size, the second bandwidth size, or both for the channel state feedback message.

17. The network entity of claim 14, wherein, to communicate the first signaling, the one or more processors are individually or collectively configured to:
receive an indication of the first bandwidth size, the second bandwidth size, or both used for the channel state feedback message.

18. The network entity of claim 14, wherein communicating the first signaling is based at least in part on a change in one or more channel metrics for the UE.

19. The network entity of claim 18, wherein the one or more processors are individually or collectively further configured to:
transmit third signaling updating a resource allocation for the channel state feedback message based at least in part on the change in the one or more channel metrics.

20. The network entity of claim 19, wherein the one or more processors are individually or collectively further configured to:
receive fourth signaling requesting an update to the resource allocation for the channel state feedback message, wherein transmitting the third signaling updating the resource allocation is further based at least in part on the fourth signaling.

21. The network entity of claim 14, wherein the one or more processors are individually or collectively further configured to:
transmit third signaling indicating a configuration for transmitting the channel state feedback message, wherein receiving the channel state feedback message is based at least in part on the configuration.

22. The network entity of claim 21, wherein, to receive the channel state feedback message, the one or more processors are individually or collectively configured to:
receive, based at least in part on the configuration, an aperiodic channel state feedback message comprising a first compression of a first parameter indicating the sub-space of the codebook for the projection, a second compression of a second parameter indicating the compression of the subset of the projection, or both.

23. The network entity of claim 21, wherein the configuration indicates a first periodicity and a second periodicity different from the first periodicity, and wherein, to receive the channel state feedback message, the one or more processors are individually or collectively configured to:
receive, according to the first periodicity, a first channel state feedback message comprising a first parameter indicating the sub-space of the codebook for the projection; and
receive, according to the second periodicity, a second channel state feedback message comprising a second compression of a second parameter indicating the compression of the subset of the projection.

24. The network entity of claim 21, wherein the third signaling comprises a radio resource control message, a medium access control control message, or a downlink control information message.

25. The network entity of claim 14, wherein the one or more processors are individually or collectively further configured to:
receive capability information for the UE indicating that the UE supports the first machine learning model for the channel projection and the second machine learning model for the vector compression, wherein communicating the first signaling is based at least in part on the capability information for the UE.

26. The network entity of claim 14, wherein:
the channel state feedback message comprises a first set of bits indicating a first compression of a first parameter indicating the sub-space of the codebook for the projection, a second set of bits indicating a second compression of a second parameter indicating the compression of the subset of the projection, or both; and
a first quantity of the first set of bits is larger than a second quantity of the second set of bits.

27. The network entity of claim 14, wherein the codebook comprises a non-discrete Fourier transform codebook of a set of non-discrete Fourier transform codebooks.

28. A method for wireless communications at a user equipment (UE), comprising:
communicating first signaling indicating a first bandwidth size and a second bandwidth size that is less than the first bandwidth size, the first bandwidth size corresponding to a first machine learning model for channel projection and the second bandwidth size corresponding to a second machine learning model for vector compression;
receiving second signaling indicating channel state information; and
transmitting a channel state feedback message based at least in part on the second signaling, the channel state feedback message indicating a sub-space of a codebook for a projection of at least a portion of the channel state information corresponding to the first bandwidth size based at least in part on the first machine learning model, a compression of a subset of the projection corresponding to the second bandwidth size based at least in part on the second machine learning model, or both.

29. The method of claim 28, wherein communicating the first signaling comprises:
receiving configuration signaling indicating the first bandwidth size, the second bandwidth size, or both for the channel state feedback message.

30. A method for wireless communications at a network entity, comprising:
communicating first signaling indicating a first bandwidth size and a second bandwidth size that is less than the first bandwidth size, the first bandwidth size corresponding to a first machine learning model for channel projection and the second bandwidth size corresponding to a second machine learning model for vector compression;
transmitting, for a user equipment (UE), second signaling indicating channel state information; and
receiving a channel state feedback message based at least in part on the second signaling, the channel state feedback message indicating a sub-space of a codebook for a projection of at least a portion of the channel state information corresponding to the first bandwidth size based at least in part on the first machine learning model, a compression of a subset of the projection corresponding to the second bandwidth size based at least in part on the second machine learning model, or both.
